(19) United States
(12) Patent Application Publication
(10) Pub. No.: US 2006/0194708 A1
(43) Pub. Date: Aug. 31, 2006

(54) Detergents or cleaning agents

(76) Inventors: Wolfgang Barthel, Langenfeld (DE); Birgit Burg, Alpen (DE); Salvatore Fileccia, Oberhausen (DE); Arno Dueffels, Duesseldorf (DE); Maren Jekel, Willich (DE); Ulf Arno Timman, Koeln (DE); Christian Nitsch, Duesseldorf (DE)

Correspondence Address: DANN DORFMAN HERRELL AND SKILLMAN;A PROFESSIONAL CORPORATION, 1601 MARKET STREET, SUITE 2400, PHILADELPHIA, PA, 19103-2307, US

(21) Appl. No.: 11/346,454

(22) Filed: Feb. 2, 2006

Related U.S. Application Data
(63) Continuation of application No. PCT/EP04/08472, filed on Jul. 29, 2004.

(30) Foreign Application Priority Data
Aug. 8, 2003 (DE) DE 103 36 796.9

(51) Int. Cl. C11D 17/00

(52) U.S. Cl. 510/337

(57) ABSTRACT

A laundry detergent or cleaning composition portion and process for producing the portion. The composition comprises a water-soluble melt adhesive comprising A) at least one homopolymer or copolymer having free carboxylic and groups based on ethylenically unsaturated monomers, B) at least one water-soluble or water-dispersible polyurethane and C) at least one inorganic or organic base. The detergent or cleaning portion may further comprise water-soluble or water-dispersible packaging materials.

### CROSS-REFERENCE TO RELATED APPLICATIONS.

This application is a continuation under 35 U.S.C. Section 365(c) and 35 U.S.C. Section 120 of International application PCT/EP2004/008472, filed Jul. 29, 2004. This application also claims priority under 35 U.S.C. Section 119 of German Application DE 103 36 796.9, filed Aug. 8, 2003. Both the international application and the German application are incorporated herein in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION.

(1) Field of the Invention

The present application provides laundry detergent or cleaning compositions. The present application relates in particular to laundry detergent or cleaning compositions comprising adhesive bonds.

Laundry detergents or cleaning compositions are nowadays available to the consumer in various supply forms. In addition to washing powders and granules, this range includes, for example, also cleaning composition concentrates in the form of extruded or tableted compositions. These solid, concentrated or compacted supply forms feature a reduced volume per dosage unit and thus lower the costs of packaging and transport. The laundry detergent or cleaning composition tablets in particular additionally fulfill the wish of the consumer for simple dosage.

As an alternative to the above-described particulate or compacted laundry detergents or cleaning compositions, solid or liquid laundry detergents or cleaning compositions which have a water-soluble or water-dispersible packaging have increasingly been described in the last few years. Like the tablets, these compositions feature simplified dosage, since they can be dosed together with the outer packaging into the washing machine or the machine dishwasher, but they secondly also simultaneously enable the formulation of liquid or pulverulent laundry detergents or cleaning compositions which feature better dissolution and more rapid activity compared to the compacted materials.

Both in the production of the compacted materials described and in the production of the cleaning compositions formulated in water-soluble packages, adhesives are used. Such adhesives serve, for example, to adhesive-bond cores in depression tablets or to seal water-soluble or water-dispersible packages.

(2) Description of Related Art, Including Information Disclosed Under 37 C.F.R. §§1.97 and 1.98

Especially in the field of the sealing of water-soluble packages, the patent literature has in recent times disclosed a series of different solutions. For instance, the International application WO 03/08486 A2 (Procter & Gamble) describes a sealing process for water-soluble films using a solvent having a viscosity between 1.5 and 15 000 mPas. The addition of plasticizers in the sealing of water-soluble films with the aid of solvent is disclosed by the International application WO 03/08513 A2 (Procter & Gamble).

### BRIEF SUMMARY OF THE INVENTION

It was an object of the present invention to provide laundry detergents or cleaning compositions comprising adhesive bonds, whose adhesive bonds are stable under the customary conditions of production, packaging, storage and transport, but dissolve reliably within a short time in an aqueous environment. Moreover, the laundry detergents or cleaning compositions comprising adhesive bonds shall be producible by high-speed manufacturing processes. The use of organic solvents shall in particular be avoided for safety reasons.

It has now been found that certain water-soluble melt adhesives are outstandingly suitable for achieving these objects.

The present application therefore firstly provides laundry detergent or cleaning composition portions comprising a water-soluble melt adhesive comprising

a) from 40 to 70% by weight of at least one homo- or copolymer having free carboxylic acid groups based on ethylenically unsaturated monomers (component A),

b) from 15 to 45% by weight of at least one water-soluble or water-dispersible polyurethane (component B) and

c) from 10 to 45% by weight of at least one inorganic or organic base (component C),

d) and also from 0 to 20% by weight of further additives.

### BRIEF DESCRIPTION OF THE SEVERAL VIEWS OF THE DRAWING(S)

Not Applicable

### DETAILED DESCRIPTION OF THE INVENTION

In the context of the present application, laundry detergent or cleaning composition portions are regarded as being compositions, for example in the form of preformulated dosage units such as tablets or sachets, which are suitable for cleaning textiles, dishware or hard surfaces. The term “laundry detergents or cleaning compositions” thus also encompasses the water-soluble or water-dispersible packaging of packaging constituents of these laundry detergents or cleaning compositions. Water-insoluble outer packagings are not encompassed by the term “laundry detergents or cleaning compositions.”

Melt adhesives are solid at room temperature and at least substantially water- and solvent-free, i.e. the amount of water/solvent is below 5% by weight. Melt adhesives are applied from the melt to the substrates to be bonded and set by solidification in the course of cooling.

Melt adhesives find wide industrial use in the packaging and paper industry for the sealing and closure of cardboard boxes. The demands that the melt adhesives have to satisfy in this branch of industry are various: for instance, the melt adhesives have to have a medium to long open time (defined as the time span between adhesive application and the fixing of the adherents), but set rapidly enough after fixing of the adherents to ensure adhesive bonding of sufficient quality, especially on high-speed packaging, paper processing or labeling machines. In addition to the setting speed, the viscosity is a further important criterion for the selection of the melt adhesive. For machine processing, especially for uniform melt adhesive application, the viscosity should be sufficiently low at appropriate application temperature. For adhesive bonds of packaging in the frozen products sector, where the packaged goods are stored at temperatures down to −35° C., a corresponding cold flexibility should be present. In other words, under cold conditions, a high strength of the adhesive bond should exist and the adhesive should not become embrittled or fracture. On the other hand, foods or drinks manufactured under warm or hot conditions are frequently packaged, so that a correspondingly high stability of the adhesive is required. Sufficiently high stability should be understood to mean that the adhesive does not soften or flow under the action of elevated temperature, resulting in the adhesion bond breaking and/or the adhesive-bonded parts being shifted relative to one another. Moreover, it is required especially for the foods industry to provide substantially odor-free or low-odor melt adhesives. Components which are used in corresponding melt adhesives have to have approval for foods. It should also be taken into account that a wide variety of different materials are adhesive-bonded to one another, such as glass, plastics, fibrous materials (paper, paperboard, polyolefin-coated cardboards) or metals and many more. Sufficient adhesion of the melt adhesive to these different materials has to be present.

Base polymers determine substantially the properties important for the melt adhesives, such as adhesion, strength and thermal behavior.

The base polymers used in melt adhesives are typically the following polymers: thermoplastic polymers such as block copolymers, for example styrene-butadiene, styrene-butadiene-styrene, styrene-isoprene-styrene, styrene-ethylene-butylene-styrene, styrene-ethylene-propylene-styrene; ethylene-vinyl acetate polymers, other ethylene-esters and copolymers, for example ethylene with acrylate, ethylene-n-butyl acrylate and ethylene-acrylic acid; polyolefins such as polyethylene and polypropylene, for example amorphous propylene-α-olefins (APAOs); polyvinyl acetate (PVAc) and PVAc copolymers, polyacrylates, polyamides, polyesters, polyvinyl alcohols (PVAs) and PVA copolymers, polyurethanes, polystyrenes, polyepoxides, copolymers of vinyl monomers and polyalkylene oxide polymers, aldehydes which contain resins, such as phenol-aldehyde, urea-aldehyde, melamine-aldehyde and the like.

The inventive melt adhesives comprise, as constituents,
a) from 40 to 70% by weight of at least one homo- or copolymer having free carboxylic acid groups based on ethylenically unsaturated monomers (component A),
b) from 15 to 45% by weight of at least one water-soluble or water-dispersible polyurethane (component B) and
c) from 10 to 45% by weight of at least one inorganic or organic base (component C),
d) and also from 0 to 20% by weight of further additives.
   In a preferred embodiment, the parts by weight of components A, B and C and also of the further additives are selected such that the sum of these four components adds up to 100% by weight. This preferred embodiment, in which the sum of the parts by weight of components A, B and C and of the further additives adds up to 100% by weight, applies not only to the inventive compositions but also additionally to the processes and uses described below.

The homo- or copolymers which are to be used in the context of the invention and have free carboxylic acid groups based on ethylenically unsaturated monomers (component A) are obtainable by homo- or copolymerization of ethylenically unsaturated monomers or oligomers which have at least one carboxyl group per molecule, as are used, for example, for the synthesis of base polymers. Preference is given to using, as component A, polymers which are obtainable by copolymerization of ethylenically unsaturated monomers or oligomers which have no carboxyl group per molecule with ethylenically unsaturated aliphatic copolymers which have at least one carboxyl group per molecule. A preferred ethylenically unsaturated monomer which does not have a carboxyl group is in particular vinyl acetate. Examples of copolymerizable ethylenically unsaturated aliphatic comonomers having at least one carboxyl group are acrylic acid, methacrylic acid, crotonic acid, isocrotonic acid, tiglic acid, maleic acid, fumaric acid, citraconic acid, mesaconic acid, itaconic acid and aconitic acid.

Further monomers may be used in the copolymerization reaction. Examples of further comonomers are ethylene, propylene, butylene, 1-hexene and anhydrides or esters of the ethylenically unsaturated copolymers which have already been mentioned and have at least one carboxyl group per molecule. The copolymer (component A) preferably has an acid number of from 10 to 200 mg KOH/g, especially preferably from 20 to 150 mg KOH/g (measured to ASTM D 974). The inventive water-soluble melt adhesive contains from 40 to 70% by weight, preferably from 45 to 65% by weight and especially preferably from 50 to 60% by weight of component A.

In a particularly preferred embodiment of the invention, the water-soluble melt adhesive comprises, as component A, a vinyl acetate-crotonic acid copolymer having an acid number of from 10 to 200 mg KOH/g, preferably from 20 to 150 mg KOH/g and especially preferably from 25 to 100 mg KOH/g (measured to ASTM D 974). The softening point of the vinyl acetate-crotonic acid copolymer is from 80 to 130° C., preferably from 90 to 120° C. (ring-ball method, DIN 52011). The molar mass (Mₙ) is between 10 000 and 60 000, preferably from 20 000 to 50 000.

Molecular weight data for polymeric compounds relate, unless stated otherwise, to the number-average molecular weight (Mₙ). All molecular weight data relate, unless stated otherwise, to values as obtainable by gel permeation chromatography (GPC).

Commercial vinyl acetate-crotonic acid copolymers are obtainable, for example, from Synthomer with the designation Synthomer MCT 5 or from Wacker from the Vinnapase® range.

As component B, the inventive water-soluble melt adhesive contains from 15 to 45% by weight, preferably from 20 to 40% by weight and especially preferably from 25 to 35% by weight of at least one water-soluble or water-dispersible polyurethane.

Polyurethanes, as usable as component B in the context of the present invention, are typically prepared by reacting at least one polyisocyanate, preferably a diisocyanate, and a polyol component which preferably consists predominantly of diols. The polyol component may contain only one polyol, but it is also possible to use a mixture of two or more different polyols as the polyol component. Particularly suitable as the polyol component or at least as part of the polyol component are, for example, polyalkylene oxides, especially polyethylene oxide.

The term “ionic” means that the polyurethane has groups which are ionic or at least ionizable in an acid-base reaction as solubility promoters, for example carboxylate, sulfonate, phosphonate or ammonium groups.

The term “nonionic” means correspondingly that the polyurethane does not have any ionic groups as emulsifying groups, i.e. no carboxylate, sulfonate, phosphonate or ammonium groups. Instead, the water solubility is based on the hydrophilic nonionic groups of the polyoxyethylene —[CH₂—CH₂—O—]—. These structural units derive in particular from the polyethylene oxide used with preference as a polyol component. However, polyethylene oxide is understood to mean not only polyaddition products of ethylene oxide to water or ethylene glycol as the starter molecule, but also polyadditions of ethylene oxide to other dihydric alcohols, for example butanediol, hexanediol or 4,4′-dihydroxydiphenylpropane. It is also possible to use mixtures of two or more different polyethylene oxides which differ, for example, in the mean molecular weight M_{w} or Mₙ or in both. It is also possible to use copolymers of ethylene oxide with higher alkylene oxides, for example with propylene oxide, as the polyol component, provided that they are sufficiently water-soluble, i.e. more than about 3 g remain dissolved in about 100 g of water at about 20° C. over about 6 months.

The polyethylene oxide in the polyol component may be replaced by up to 10% by weight, preferably up to at most 5% by weight, in particular up to at most 2% by weight, by other diols which contain a hydrophobic radical having a water solubility of at most 2 g/100 g of water. The hydrophobic radical is in particular aliphatic or alicyclic structures having from 2 to 44, in particular from 6 to 36 carbon atoms. The radicals may also contain aromatic structures. Preference is given to diols having at least one primary OH group, especially 1,2- or α,ω-diols. However, diols with vicinal arrangement of the OH groups are also suitable.

The polyethylene oxide in the polyol component preferably has a molecular weight (Mₙ) of from about 200 to about 20 000, in particular from about 1000 to about 15 000, for example about 1550, 3000, 6000 or 12 000.

Moreover, up to 10%, preferably from 0.5 to 5%, of the polyethylene glycol may be replaced by hydrophobic homopolymeric polyalkylene glycols, the alkylene group having more than 2, preferably 3 or 4 carbon atoms. Their molecular weights are in particular from 150 to 10 000 g/mol. Specific examples of hydrophobic diols with pure CH radicals and with ether moieties are polypropylene glycol (PPG), polybutylene glycol, polytetrahydrofuran, polybutadienediol, hydroxyl-terminated ethylene-butylene copolymers (for example KRATON LIQUID Polymer L-2203), hydrogenated polybutadienediol, and alkanediols having from 4 to 44 carbon atoms. Preferred hydrophobic diols are polypropylene glycol, polytetrahydrofuran having a molecular weight of from 150 to 10 000, in particular from 200 to 4500, more preferably from 250 to 1000, and also 1,10-decanediol, 1,12-dodecanediol, 1,12-octadecanediol, dimer fatty acid diol, 1,2-octanediol, 1,2-dodecanediol, 1,2-hexadecanediol, 1,2-octadecanediol, 1,2-tetradecanediol, 4,4-isopropylidenedicyclohexanol and their isomer mixtures, 4,8-bis(hydroxymethyl)tricyclo[5.2.1.0^{2,6}]decanes and their isomer mixtures, 1,4:3,6-dianhydro-D-mannitol, 1,4:3,6-dianhydro-D-sorbitol, 1,16-hexadecanediol, bisphenol A, and also their prop- or ethoxylation products or mixtures thereof, especially with up to 30 EO units, and finally mono fatty acid esters of glycerol with fatty acids containing up to 22 carbon atoms, for example glycerol monoesters of behenic acid, oleic acid, stearic acid, myristic acid. Of course, it is also possible to use mixtures of two or more of the hydrophobic diols mentioned.

The polyethylene glycol may also be replaced to an extent of from 0 to 5%, in particular from 0.2 to 2%, by higher-functionality alcohols, especially by triols, for example by glycerol, trimethylolpropane, triethanolamine or their ethoxylated or propoxylated variants. It is also possible to use pentaerythritol. Also possible are ethoxylated or propoxylated variants of amines or amino alcohols, for example starting from ethylenediamine, diethylenetriamine and their higher homologues, for example aminophenol, N-2-aminoethylpiperazine.

In order to obtain particularly high molecular weight polyurethanes, maximum-purity diols should be used. For this purpose, the content of alkali metal and alkaline earth metal ions should be below 500 ppm, in particular below 150 ppm and preferably below 10 ppm. Moreover, the water content should be below 0.5% by weight, in particular below 0.1% by weight, preferably below 0.05% by weight, according to K. Fischer.

In addition to the diols of the polyol component, diisocyanates are essential units of the polyurethane usable as component B. They are compounds of the general structure O═C═N—X—N═C═O where X is an aliphatic, alicyclic or aromatic radical, preferably an aliphatic or alicyclic radical having from 4 to 18 carbon atoms.

Examples of suitable isocyanates include naphthylene 1,5-diisocyanate, diphenylmethane 4,4′-diisocyanate (MDI), hydrogenated MDI (H₁₂-MDI), xylylene diisocyanate (XDI), tetramethylxylylene diisocyanate (TMXDI), diphenyidimethylmethane 4,4′-diisocyanate, di- and tetraalkylenediphenylmethane diisocyanate, dibenzyl 4,4′-diisocyanate, phenylene 1,3-diisocyanate, phenylene 1,4-diisocyanate, the isomers of tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, bisisocyanatoethyl phthalate, and also diisocyanates with reactive halogen atoms such as 1-chloromethylphenyl 2,4-diisocyanate, 1-bromomethylphenyl 2,6-diisocyanate or 3,3-bischloromethyl ether 4,4′-diphenyldiisocyanate. Sulfur-containing polyisocyanates are obtained, for example, by reacting 2 mol of hexamethylene diisocyanate with 1 mol of thiodiglycol or dihydroxydihexyl sulfide. Further usable diisocyanates are, for example, trimethylhexamethylene diisocyanate, 1,4-diisocyanatobutane, 1,12-diisocyanatododecane and dimer fatty acid diisocyanate.

Particularly suitable are: tetramethylene diisocyanate, hexamethylene diisocyanate, undecane diisocyanate, dodecamethylene diisocyanate, trimethylhexane 2,2,4-diisocyanate, cyclohexane 1,3-diisocyanate, cyclohexane 1,4-diisocyanate, tetramethylxylene 1,3- or 1,4-diisocyanate, isophorone diisocyanate, dicyclohexylmethane 4,4-diisocyanate and lysine ester diisocyanate. Very particular preference is given to tetramethylxylylene diisocyanate (TMXDI), especially the m-TMXDI obtainable from Cyanamid.

To further increase the molecular weight, it is possible, for example, to undertake a chain extension in a known manner. To this end, prepolymers are first prepared with excess diisocyanate and are then subsequently extended with short-chain amino alcohols, diols, diamines or with water while increasing the molecular weight. To this end, prepolymers are first prepared with excess diisocyanate and are then subsequently extended with short-chain diols or diamines or with water. Specific chain extenders include:
saturated and unsaturated glycols such as ethylene glycol or condensates of ethylene glycol, butane-1,3-diol, butane-1,4-diol, 2-butene-1,4-diol, 2-butyne-1,4-diol, propane-1,2-diol, propane-1,3-diol, neopentyl glycol, hexanediol, bishydroxymethylcyclohexane, dioxyethoxyhydroquinone, bisglycol terephthalate, -di-2-hydroxyethylsuccinamide, N,N-dimethyl(2-hydroxyethyl)succinamide, 1,4-di(2-hydroxymethylmercapto)-2,3,5,6-tetrachlorobenzene, 2-methylenepropane-1,3-diol, 2-methylpropane-1,3-diol, 3-pyrrolidinopropane-1,2-diol, 2-methylpentane-2,4-diol, 3-alkoxypropane-1,2-diol, 2-ethylhexane-1,3-diol, 2,2-dimethylpropane-1,3-diol, pentane-1,5-diol, 2,5-dimethylhexane-2,5-diol, 3-phenoxypropane-1,2-diol, 3-benzyloxypropane-1,2-diol, 2,3-dimethylbutane-2,3-diol, 3-(4-methoxyphenoxy)propane-1,2-diol and hydroxymethylbenzyl alcohol;
aliphatic, cycloaliphatic and aromatic diamines such as ethylenediamine,
hexamethylenediamine, 1,4-cyclohexylenediamine, piperazine, N-methylpropylenediamine, diaminodiphenylsulfone, diaminodiphenyl ether, diaminodiphenyidimethylmethane, 2,4-diamino-6-phenyltriazine, isophoronediamine, dimer fatty acid diamine, diaminodiphenylmethane or the isomers of phenylenediamine;
and also carbohydrazides or hydrazides of dicarboxylic acids;
amino alcohols such as ethanolamine, propanolamine, butanolamine, N-methylethanolamine, N-methylisopropanolamine, diethanolamine, triethanolamine and higher di- or tri(alkanolamines);
aliphatic, cycloaliphatic, aromatic and heterocyclic mono- and diaminocarboxylic acids such as glycine, 1- and 2-alanine, 6-aminocaproic acid, 4-aminobutyric acid, the isomeric mono- and diaminobenzoic acids and the isomeric mono- and diaminonaphthoic acids.

However, preference is given to preparing the polyurethane in a one-stage process. In this case, for example, all starting materials are first mixed in the presence of an organic solvent at a water content of less than 0.5% by weight. The mixture is heated to from 60 to 200° C., in particular to from 80 to 180° C. and preferably to from 100 to 150° C. for from approx. 1 to 30 hours.

The reaction time can be shortened by presence of catalysts. Especially suitable are tertiary amines, for example triethylamine, 1,4-diazabicyclo[2.2.2]octane (=DABCO), dimethylbenzylamine, bisdimethylaminoethyl ether and bismethylaminomethylphenol. Particularly suitable are 1-methylimidazole, 2-methyl-1-vinylimidazole, 1-allylimidazole, 1-phenylimidazole, 1,2,4,5-tetramethylimidazole, 1-(3-aminopropyl)imidazole, pyrimidazole, 4-dimethylaminopyridine, 4-pyrrolidinopyridine, 4-morpholinopyridine, 4-methylpyridine.

It is also possible to use organotin compounds as catalysts. These are understood to mean compounds which contain both tin and an organic radical, especially compounds which contain one or more Sn—C bonds. In the wider sense, the organotin compounds include, for example, salts such as tin octoate and tin stearate. In the narrower sense, the tin compounds include in particular compounds of tetravalent tin of the general formula Rₙ₊₁SnX₃₋ₙ where n is from 0 to 2, R is an alkyl group or an aryl group or both, and X is finally an oxygen, sulfur or nitrogen compound or a mixture of two or more thereof. Appropriately, R contains at least 4 carbon atoms, in particular at least 8. The upper limit is generally at 12 carbon atoms. X is preferably an oxygen compound, i.e. an organotin oxide, hydroxide, carboxylate or an ester of an inorganic acid. X may also be a sulfur compound, i.e. an organotin sulfide, thiolate or a thio acid ester. Suitable Sn—S compounds are in particular thioglycolic esters, for example compounds with the following radicals:
—S—CH₂—CH₂—CO—O—(CH₂)₁₀—CH₃ or
—S—CH₂—CH₂—CO—O—CH₂—CH(C₂H₅)—CH₂—CH₂—CH₂—CH₃.

Such compounds fulfill a further selection rule: the molecular weight of the organotin compound should, in a preferred embodiment of the invention, be above 250, in particular above 600.

A further preferred class of compounds is that of the dialkyltin(IV) carboxylates (X═O—CO—R¹). The carboxylic acids have 2, preferably at least 10, in particular from 14 to 32 carbon atoms. It is also possible to use dicarboxylic acids. Suitable acids are, for example, adipic acid, maleic acid, fumaric acid, terephthalic acid, phenylacetic acid, benzoic acid, acetic acid, propionic acid and in particular caprylic acid, capric acid, lauric acid, myristic acid, palmitic acid and stearic acid. Particularly suitable examples are dibutyltin diacetate and dilaurate, and also dioctyltin diacetate and dilaurate.

Tin oxides and sulfides and also thiolates are also suitable in the context of the present invention. Specific compounds are: bis(tributyltin) oxide, dibutyltin didodecylthiolate, dioctyltin dioctylthiolate, dibutyltin bis(2-ethylhexyl thioglycolate), octyltin tris(2-ethylhexyl thioglycolate), dioctyltin bis(thioethylene glycol 2-ethylhexoate), dibutyltin bis(thioethylene glycol laurate), dibutyltin sulfide, dioctyltin sulfide, bis(tributyltin) sulfide, dibutyltin bis(2-ethylhexyl thioglycolate), dioctyltin bis(thioethylene glycol 2-ethylhexoate), trioctyltin thioethylene glycol 2-ethylhexoate and dioctyltin bis(2-ethylhexyl thiolatoacetate), bis(S,S-methoxycarbonylethyl)tin bis(2-ethylhexyl thiolatoacetate), bis(S,S-acetylethyl)tin bis(2-ethylhexyl thiolatoacetate), tin(II) octylthiolate, and tin(II) thioethylene glycol 2-ethylhexoate.

Mention should also be made of: dibutyltin diethoxide, dihexyltin dihexoxide, dibutyltin diacetylacetonate, dibutyltin diethylacetylacetate, bis(butyidichlorotin) oxide, bis(dibutylchlorotin) sulfide, tin(II) phenoxide, tin(II) acetylacetonate, and also further α-dicarbonyl compounds such as acetylacetone, dibenzoylmethane, benzoylacetone, ethyl acetoacetate, n-propyl acetoacetate, ethyl α,α′-diphenylacetoacetate and dehydroacetic acid.

The catalyst is preferably added to the polyol. Its amount depends upon its activity and the reaction conditions. It is preferably in the range from 0.001 to 0.5% by weight based on the polyol.

However, preference is given to working without catalyst. The solvent too is appropriately omitted. In the context of the present text, “solvents” are understood to mean inert organic liquid substances having a boiling point of less than 200° C. at standard pressure (1 bar).

The reaction is preferably undertaken in such a way that the ratio of OH groups in the polyol component to NCO groups in the polyisocyanate is from about 1.0 to about 2.0, in particular from about 1.05 to 1.8, for example from about 1.1 to 1.7 or from about 1.3 to 1.6.

One means of introducing ion-forming structural elements is the reaction of OH-terminated polyurethane oligomers with dicarboxylic anhydrides. These may contain a total of from 2 to 44, preferably from 2 to 12 carbon atoms between the bisacyl groups, such as alkylene, alkenylene or arylene moiety. Suitable examples are succinic anhydride, glutaric anhydride, 1,2,3,6-tetrahydrophthalic anhydride and its isomers, phthalic anhydride, trimellitic anhydride, 7-oxabicyclo[2.2.1 ]hept-5-ene-2,3-dicarboxylic anhydride, 5-norbornene-2,3-dicarboxylic anhydride and their isomers, diglycolic anhydride, maleic anhydride, dimethylmaleic anhydride, citraconic anhydride, itaconic anhydride, alkenylsuccinic anhydrides, preferably those whose alkenyl groups have more than 2 carbon atoms, in particular more than 5 carbon atoms, more preferably more than 7 carbon atoms. Specific mention should be made of: n-octenylsuccinic anhydride, n-dodecenylsuccinic anhydride, tetrapropenylsuccinic anhydride, n-hexadecenylsuccinic anhydride and n-octadecenylsuccinic anhydride. The alkenyl radical may have a linear or branched structure. Moreover, mixtures of alkenyl groups having a different number of carbon atoms may also occur. Mixtures of a plurality of anhydrides are also possible, but preference is given to cyclic anhydrides.

However, it is also possible to use a molar excess of isocyanates, in which case NCO-terminated oligomers form.

Although NCO groups in the end product are generally undesired, they can be used in order, for example, to introduce hydrophobic or ionic structural elements.

Hydrophobic structural elements may be obtained, for example, by reacting NCO-terminated oligomers with monools or monofunctional amines having ≧2 carbon atoms, in particular ≧6, ≧10 or ≧16 carbon atoms. Specific mention should be made of: polyethylene/butylene with 1 OH group, for example with an OH equivalent weight of 3600 (Kraton L 1203), and also 1-hexanol, 1-heptanol, 1-octanol, 1-nonanol, 1-decanol, 1-undecanol, 10-undecen-1-ol, 1-dodecanol, 1-tridecanol, 1-tetradecanol, 1-pentadecanol, 1-hexadecanol, 1-heptadecanol, 1-octadecanol, 9-cis-octadecen-1-ol, 9-trans-octadecen-1-ol, 9-cis-octadecen-1,12-diol, all-cis-9,12-octadecadien-1-ol, all-cis-9,12,15-octadecatrien-1-ol, 1-nonadecanol,1-eicosanol, 9-cis-eicosen-1-ol, 5,8,11,14-eicosatetraen-1-ol, 1-heneicosanol, 1-docosanol, 13-cis-docosen-1-ol, 13-trans-docosen-1-ol. The corresponding fatty amines are also possible as hydrophobizing structural elements.

A further means of introducing ion-forming structures is finally the reaction of NCO-terminated oligomers with hydroxycarboxylic acids or amino carboxylic acids with alkylene, alkylene or arylene moieties, as for the dicarboxylic anhydrides. Examples include: glycolic acid, lactic acid, caproic acid and mandelic acid, and also aminocaproic acid, aminododecanoic acid, glycine, alanine and phenylalanine.

In a preferred embodiment of the invention, the component B used is a nonionic polyurethane having a molecular weight (Mₙ) of at least about 2000, in particular a nonionic polyurethane which is obtainable by reaction of at least one polyisocyanate with at least one polyalkylene glycol having a molecular weight of at least 1000. The nonionic polyurethane used as component B has a viscosity at 150° C. of from 500 to 80 000 mPas, preferably from 1000 to 60 000 mPas and especially preferably from 2000 to 40 000 mPas (measured to Brookfield, spindle 27, ASTM D 3236-88).

The use of the nonionic polyurethane leads to better product stability/homogeneity of the adhesive in production and application. It improves especially the rheological properties of the adhesive composition. This is found, for example, in the case of use on high-speed machines (approx. 600 m/min): with the inventive melt adhesives, uniform adhesive threads and no spots are obtained on application with spray systems.

Component A is preferably present as a salt. In the inventive water-soluble melt adhesive, the inorganic or organic base used as component C serves to bring about the solubilization of component A in the course of mixing of the adhesive composition with water. To this end, the inorganic bases used may, for example, be sodium hydroxide solution or potassium hydroxide solution.

The group of the organic bases includes, for example, aliphatic amino alcohols. In the context of the present invention, preference is given to the use of alkanolamines, especially trialkanolamines, having from 2 to 6 carbon atoms in the alkanol radical, where the length of the carbon chain in the alkanol radicals of one molecule may be the same or different. Especially in the case of use of triethanolamine, a clear solution of the melt adhesive in water is obtained.

A melt adhesive which is particularly preferred in the context of the present application is characterized in that the water-soluble melt adhesive comprises, as component C, an alkanolamine, preferably a trialkanolamine, especially preferably triethanolamine, having from 2 to 6 carbon atoms in the alkanol radical, where the length of the carbon chain in the alkanol radicals of one molecule may be the same or different.

The amount of component C in the inventive water-soluble melt adhesive is from 10 to 45% by weight, preferably from 12 to 35% by weight and especially preferably from 15 to 25% by weight.

The melt adhesive may contain from 0 to 20% by weight of further additives, for example base polymers, plasticizers, rheological additives, antioxidants, UV stabilizers, dyes or tackifying resins (tackifiers), and also water and/or organic solvents up to not more than 3% by weight, provided that these additives do not impair the water solubility of the melt adhesive composition.

The tackifiers used are, for example, hydrocarbon resins, especially C5 or C9 resins, or C9 resins modified with C5 resins. Also suitable for use as tackifiers are resins based on pure hydrocarbon monomers, for example resins as obtainable from the polymerization of mixtures of styrene, α-methylstyrene and vinyltoluene. The hydrocarbon resins mentioned may be partly hydrogenated or fully hydrogenated.

Likewise suitable for use as tackifiers are natural resins such as balsam resin, as obtained, for example, from trees, or tall resin which is obtained in papermaking. The natural resins may be used as tackifiers in the abovementioned form, but it is equally possible to use the resins mentioned as pentaerythritol esters, glycerol esters, diethylene glycol esters, triethylene glycol esters or methyl esters after esterification with corresponding polyfunctional alcohols.

Equally suitable as tackifiers are the polyterpene resins. Terpenes are obtained in the separation of resin acids from their natural solvents and can be polymerized to polyterpene resins. Likewise suitable for use as tackifiers are the terpene-phenol resins obtainable from polyterpene resins by phenol modification. Preference is given to water-soluble tackifiers.

The antioxidants used are antioxidants known to those skilled in the art. These are antioxidants based on thioethers, hindered and/or multifunctional phenols, hydroxylamine or organic phosphorus compounds, for example organic diphosphites. The antioxidants are used individually or in a mixture. Preference is given to using water-soluble antioxidants. Typical commercially available antioxidants are supplied by Ciba under the trade names Irganox 1010 and Irganox 1076. The amount of antioxidants in the overall composition is from 0.05 to 2.5% by weight, preferably from 0.1 to 2% by weight and especially preferably from 0.25 to 1.5% by weight.

The additives may be present in the melt adhesive individually or as a mixture of two or more of the substances mentioned. The amount of the additives should not exceed about 20% by weight (based on the overall melt adhesive). Examples of suitable amounts are from about 0.1 to about 15% by weight, or from about 1 to about 10% by weight. In a preferred embodiment of the invention, for example, about 2, 3, 4, 5, 7 or 9% by weight of additives are used.

The inventive water-soluble melt adhesive has a viscosity which allows the melt adhesive to be used in customary application processes. Advantageously, the melt adhesive therefore has a viscosity (Brookfield Thermosell, spindle 27, ASTM D 3236-88) which is within a range from 1000 mPas to 20 000 mPas, preferably from 1500 mPas to 15 000 mPas and especially preferably from 2000 to 8000 mPas at 120° C.

Melt adhesives preferred in accordance with the invention are water-soluble, i.e. an amount of 3 g of the melt adhesive dissolves fully in 600 g of water at a pH between 5 and 8 and a temperature of 40° C. “Full dissolution” is understood to mean that no tacky, dispersed particles form in water, and a molecularly disperse solution preferably forms.

The water solubility of melt adhesives used according to the invention in laundry detergents or cleaning compositions is determined on the basis of the European Standard EN 1720. According to this, two 800 ml beakers are charged with 600 g of water in each case. The water in the first beaker (BG1) is adjusted to pH 5 (±0.1) with phosphoric acid solution (1 part of phosphoric acid to 100 parts of water). The water in the second beaker (BG2) is adjusted to pH 8 (+0.1) with aqueous sodium hydroxide solution (1 part of NaOH to 100 parts of water). Both beakers are heated to 40° C. Two samples of 3 g of the adhesive in each case are prepared by cutting a dried adhesive film of approx. 200 g/m² into 1 cm² pieces. In each case 3 g of the cut adhesive film samples are introduced into the beakers BG1 and BG2 with stirring and stirred at 40° C. for 90 min. Subsequently, the contents of BG1 and BG2 are immediately*) filtered fully through a filter with a pore size of 100 micrometers in each case, the weight of the filter having been determined before the filtration. The filters are dried to constant mass in a drying cabinet at 60° C. for 2 hours and subsequently weighed. An amount of from 0 to 0.5% by weight of filter residue, based on the amount of adhesive used, shows that the adhesive is readily dispersible. (*)N.B.: immediately before the filtration operation, there is a visual test of whether the dispersion of the adhesive pieces has led to an opaque/translucent or clear solution. The visual testing takes place in comparison to water as a standard. The standard is BG1 and BG2 without adhesive film pieces. The inventive adhesives do not exhibit any visible difference from the standard, i.e. are clearly soluble.)

The inventive water-soluble melt adhesive is processed generally by application of the adhesive by means of customary application processes in the molten state. Suitable application processes are, for example, application by means of rolls, slot dies or spray nozzles and template application. In particular, it is preferred to pretreat at least one of the objects to be adhesive-bonded with the water-soluble melt adhesive. For example, in the process according to the invention described below, particular preference is given to using water-soluble or water-dispersible closure parts, especially water-soluble or water-dispersible films which have a prefabricated, at least partial coating with the water-soluble melt adhesive. When such closure parts, especially films, are used, the dosage of the water-soluble melt adhesives is dispensed with in the corresponding processes. The closure parts, especially films, can be adhesive-bonded in a simple manner by heating these closure parts, especially films. The apparatus demands for the performance of the processes according to the invention are distinctly reduced in this way.

When application is effected by means of a roll, it is generally only possible to realize quite high basis weights of adhesive. For the roll application, suitable examples of melt adhesives are those which have a melt viscosity (Brookfield Thermosell, spindle 27, ASTM D 3236-88) at from about 120 to about 150° C. of from about 1000 to about 6000 mPas, in particular from about 2000 to about 3000 mPas.

When the melt adhesive is applied by means of a slot die, this is generally done by using a melt adhesive which has a melt viscosity (Brookfield Thermosell, spindle 27, ASTM D 3236-88) at from about 120 to about 150° C. of from about 400 to about 20 000 mPas, in particular from about 600 to about 5000 mPas.

However, the application of the melt adhesive can also be realized by means of a spray nozzle, in which case full-surface application is not obtained. It is possible to use either atomizing or nonatomizing spray nozzles; in the latter case, reference is also made to spin sprays. Atomizing spray nozzles generally require a melt adhesive which has a melt viscosity (Brookfield Thermosell, spindle 27, ASTM D 3236-88) at from about 120 to about 150° C. of from about 400 to about 10 000 mPas, in particular from about 600 to about 5000 mPas. Nonatomizing spray nozzles require melt adhesives having a slightly higher viscosity in order to ensure the required thread cohesion. Suitable examples are melt adhesives having a melt viscosity (Brookfield Thermosell, spindle 27) of from about 3000 to about 10 000 mPas at a temperature of from about 120 to about 150° C.

In a further preferred embodiment, melt adhesives are used which have an open time of from about 0.1 to about 10 seconds, for example from about 0.2 to about 8 seconds, more preferably from about 0.5 to about 6 seconds.

Particular preference is given to using melt adhesives which are miscible to a substantially unlimited degree with water, i.e. which do not have a miscibility gap at a concentration of at least about 10% by weight or more, for example about 20% by weight or about 50% by weight or higher.

As stated at the outset, the term “laundry detergent or cleaning composition portion” in the context of the present application encompasses compositions, for example in the form of prefabricated dosage units such as tablets or sachets, which are suitable for cleaning textiles, dishware or hard surfaces. The term “laundry detergents or cleaning compositions” also encompasses the water-soluble or water-dispersible packaging or packaging constituents of these laundry detergents or cleaning compositions. Water-insoluble outer packagings are not encompassed by the term “laundry detergents or cleaning compositions.” The water-soluble melt adhesive preferably serves for the adhesive bonding of individual constituents of inventive laundry detergents or cleaning compositions. Accordingly, the group of inventive laundry detergent or cleaning composition portions includes, for example,
laundry detergent or cleaning composition tablets adhesive-bonded to one another;
laundry detergent or cleaning composition depression tablets with a filling adhesive-bonded in the depression;
(filled) laundry detergent or cleaning composition depression tablets with an adhesive-bonded water-soluble or water-dispersible closure part which at least partly closes the depression;
water-soluble or water-dispersible outer packagings, sealed at least partly by adhesive bonding, for laundry detergents or cleaning compositions, such as thermoformed, injection-molded or bottle-blown water-soluble or water-dispersible receiving vessels with water-soluble or water-dispersible closure parts.

In a further preferred embodiment of the present application, the laundry detergent or cleaning composition comprises at least one tablet, preferably at least one depression tablet. Such tablets or depression tablets are obtainable, for example, by compacting processes such as tableting, by extrusion or by casting processes. In the context of the present application, particular preference is given to tablets or depression tablets which are prepared by tableting or by casting processes.

Laundry detergent or cleaning composition tablets are produced in a manner known to those skilled in the art by compressing particulate starting substances. To produce the tablets, the premixture is compacted in a so-called die between two punches to give a solid compact. This operation, which is referred to hereinbelow as tableting for short, divides into four sections: dosage, compaction (elastic reshaping), plastic reshaping and ejection. The tableting is preferably effected on so-called rotary presses.

In the case of tableting with rotary presses, it has been found to be advantageous to perform the tableting with minimum weight deviations in the tablet. In this way, it is also possible to reduce the hardness variations of the tablet. Small weight variations can be achieved in the following way:
use of plastic inlays having low thickness tolerances
low rotation rate of the rotor
large filling shoe
adjustment of the filling shoe vane rotation rate to the rotation rate of the rotor
filling shoe with constant powder height
decoupling of filling shoe and powder reservoir

To reduce caking on the punches, it is possible to use any anti-adhesion coatings known from the art. Particularly advantageous anti-adhesion coatings are plastic coatings, plastic inlays or plastic punches. Rotating punches have also been found to be advantageous, in the case of which upper punch and lower punch should be configured in a rotatable manner if possible. In the case of rotating punches, it is generally possible to dispense with a plastic inlay. In this case, the punch surfaces should be electro-polished.

Processes preferred in the context of the present invention are characterized in that the compression is effected at pressures of from 0.01 to 50 kNcm⁻², preferably from 0.1 to 40 kNcm⁻² and in particular from 1 to 25 kNcm⁻².

The production of inventive preferred castings is effected, for example, by casting a washing- or cleaning-active formulation in a mold and subsequently demolding the solidified cast body to form a (depression) tablet. The “molds” used are preferably tools which have cavities which can be filled with castable substances. Such tools may, for example, be in the form of individual cavities or else in the form of plaques with a plurality of cavities. The individual cavities or cavity plaques are, in industrial processes, preferably mounted on horizontal conveyor belts which enable continuous or batchwise transport of the cavities, for example along a series of different working stations (for example: casting, cooling, filling, sealing, demolding, etc.).

In the preferred process, the washing- or cleaning-active formulations are cast and subsequently solidify to a dimensionally stable body. In the context of the present invention, “solidify” characterizes any curing mechanism which affords a body solid at room temperature from a reshapeable, preferably free-flowing mixture or such a substance or such a mass without pressing or compacting forces being necessary. In the context of the present invention, “solidify” is therefore, for example, the curing of melts of substances solid at room temperature by cooling. In the context of the present application, “solidification processes” are also the curing of reshapeable masses by time-delayed water binding, by evaporation of solvents, by chemical reaction, crystallization, etc., and also the reactive curing of free-flowing powder mixtures to stable hollow bodies.

Suitable for processing in the process described are generally all washing- or cleaning-active formulations which can be processed by casting techniques. However, particular preference is given to using washing- or cleaning-active formulations in the form of dispersions. In a particularly preferred embodiment of the present application, the washing- or cleaning-active formulation cast into the receiving depression of the mold is a dispersion of solid particles in a dispersant, particular preference being given to dispersions which, based on their total weight, contain
i) from 10 to 85% by weight of dispersant and
ii) from 15 to 90% by weight of dispersed substances.

In this application, a dispersion refers to a system of a plurality of phases of which one is a continuous phase (dispersant) and at least one a further finely divided phase (dispersed substances). Particularly preferred washing- or cleaning-active formulations are characterized in that they comprise the dispersant in amounts above 11% by weight, preferably above 13% by weight, more preferably above 15% by weight, even more preferably above 17% by weight and in particular above 19% by weight, based in each case on the total weight of the dispersion. It is also preferably possible to use formulations which have a dispersion with a proportion by weight of dispersant above 20% by weight, preferably above 21% by weight and in particular above 22% by weight, based in each case on the total weight of the dispersion. The maximum content in preferred dispersions of dispersant is, based on the total weight of the dispersion, preferably less than 63% by weight, preferentially less than 57% by weight, more preferably less than 52% by weight, even more preferably less than 47% by weight and in particular less than 37% by weight. In the context of the present invention, especially those washing- or cleaning-active formulations are preferred which, based on their total weight, contain dispersants in amounts of from 12 to 62% by weight, preferably from 17 to 49% by weight and in particular from 23 to 38% by weight.

The dispersants used are preferably water-soluble or water-dispersible. The solubility of these dispersants at 25° C. is preferably more than 200 g/l, preferably more than 300 g/l, more preferably more than 400 g/l, even more preferably between 430 and 620 g/l and in particular between 470 and 580 g/l.

In the context of the present invention, suitable dispersants are preferably the water-soluble or water-dispersible polymers, especially the water-soluble or water-dispersible nonionic polymers. The dispersant may be either an individual polymer or mixtures of different water-soluble or water-dispersible polymers. In a further preferred embodiment of the present invention, the dispersant, or at least 50% by weight of the polymer mixture, consists of water-soluble or water-dispersible nonionic polymers from the group of the polyvinylpyrrolidones, vinylpyrrolidone/vinyl ester copolymers, cellulose ethers, polyvinyl alcohols, polyalkylene glycols, especially polyethylene glycol and/or polypropylene glycol.

Particular preference is given to using dispersions which comprise, as a dispersant, a nonionic polymer, preferably a poly(alkyene) glycol, preferentially a poly(ethylene) glycol and/or a poly(propylene) glycol, the proportion by weight of the poly(ethylene) glycol in the total weight of all dispersants being preferably between 10 and 90% by weight, more preferably between 30 and 80% by weight and in particular between 50 and 70% by weight. Particular preference is given to dispersions in which the dispersant consists to an extent of more than 92% by weight, preferably to an extent of more than 94% by weight, more preferably to an extent of more than 96% by weight, even more preferably to an extent of more than 98% by weight and in particular to an extent of 100% by weight of a poly(alkylene) glycol, preferably poly(ethylene) glycol and/or poly(propylene) glycol, but in particular poly(ethylene) glycol. Dispersants which, in addition to poly(ethylene) glycol, also comprise poly(propylene) glycol preferably have a ratio of parts by weight of poly(ethylene) glycol to poly(propylene) glycol of between 40:1 and 1:2, preferably between 20:1 and 1:1, more preferably between 10:1 and 1.5:1 and in particular between 7:1 and 2:1.

Further preferred dispersants are the nonionic surfactants which may be used alone, but more preferably in combination with a nonionic polymer. Detailed remarks on the usable nonionic surfactants can be found below in the context of the description of washing- or cleaning-active substances.

Suitable dispersed substances in the context of the present application are all washing- or cleaning-active substances solid at room temperature, but in particular washing- or cleaning-active substances from the group of the builders (builders and cobuilders), the washing- or cleaning-active polymers, the bleaches, the bleach activators, the glass corrosion protectants, the silver protectants and/or the enzymes. A more precise description of these ingredients can be found below in the text.

The compositions used with preference as laundry detergent or cleaning composition tablets feature a high density. Particular preference is given to using tablets with a density above 1.040 g/cm³. Compositions preferred in accordance with the invention are characterized in that they have density above 1.040 g/cm³, preferably above 1.15 g/cm³, more preferably above 1.30 g/cm³ and in particular above 1.40 g/cm³. This high density does not only reduce the total volume of a dosage unit tablet, but also simultaneously improves its mechanical stability. Particularly preferred inventive combination products are therefore characterized in that the laundry detergent or cleaning composition tablet has a density between 1.050 and 1.670 g/cm³, preferably between 1.120 and 1.610 g/cm³, more preferably between 1.210 and 1.570 g/cm³, even more preferably between 1.290 and 1.510 g/cm³ and in particular between 1.340 and 1.480 g/cm³. The density data each relate to the densities of the compositions at 20° C.

Dispersions used with preference in accordance with the invention as laundry detergent or cleaning composition tablets feature dissolution in water (40° C.) within less than 9 minutes, preferably less than 7 minutes, preferentially within less than 6 minutes, more preferably within less than 5 minutes and in particular within less than 4 minutes. To determine the solubility, 20 g of the dispersion are introduced into the interior of a machine dishwasher (Miele G 646 PLUS). The main wash cycle of a standard wash program (45° C.) is started. The solubility is determined by the measurement of the conductivity, which is recorded by means of a conductivity sensor. The dissolution procedure has ended on attainment of the conductivity maximum. In the conductivity diagram, this maximum corresponds to a plateau. The conductivity measurement begins with the use of the circulation pump in the main wash cycle. The amount of water used is 5 liters.

It is possible by casting processes to produce both compact bodies and hollow molds. When a cast washing- or cleaning-active formulation is allowed to solidify in the cavity of the mold, simple, compact bodies are produced. However, more advantageously, and preferably in the context of the present application, laundry detergent or cleaning composition tablets are produced in the form of cast hollow bodies.

The moldings produced by tableting or casting, especially the depression tablets, may assume any geometric shape, preference being given in particular to concave, convex, biconcave, biconvex, cubic, tetragonal, orthorhombic, cylindrical, spherical, cylinder segment-like, disk-shaped, tetrahedral, dodecahedral, octahedral, conical, pyramidal, ellipsoidal, pentagonally, heptagonally and octagonally prismatic, and rhombohedral shapes. It is also possible to realize entirely irregular outlines such as arrow or animal shapes, trees, clouds, etc. When the inventive tablets have corners and edges, these are preferably rounded off. As an additional visual differentiation, preference is given to an embodiment with rounded corners and beveled (chamfered) edges.

The tablets or depression tablets can of course also be produced in multiphase form. For reasons of process economics, two-layer tablets have been found to be particularly useful here.

The shape of the cavity may also be freely selected within wide limits. Thus, the depressions of the inventive tablets may assume any geometric shape, preference being given in particular to concave, convex, biconcave, biconvex, cubic, tetragonal, orthorhombic, cylindrical, spherical, cylinder segment-like, disk-shaped, tetrahedral, dodecahedral, octahedral, conical, pyramidal, ellipsoidal, pentagonally, heptagonally and octagonally prismatic, and rhombohedral shapes. It is also possible to realize entirely irregular depression outlines such as arrow or animal shapes, trees, clouds, etc. When the depression periphery has corners and edges, these are preferably rounded off. As an additional visual differentiation, preference is given to an embodiment with rounded corners and beveled (chamfered) edges.

The size of the depression in comparison to the entire tablet depends upon the desired end use of the tablets. Irrespective of the end use, preference is given to laundry detergent and cleaning composition tablets in which the volume ratio of tablet to cavity is from 2:1 to 100: 1, preferably from 3:1 to 80: 1, more preferably from 4:1 to 50:1 and in particular from 5:1 to 30:1. The volume ratio is calculated from the volume of the inventive finished tablet, i.e. of the tablet which has the cavity, and the fill volume of the cavity. The difference in the two volumes gives the volume of the tablet with cavity. In other words: when the tablet has, for example, an orthorhombic shape having the side lengths 2, 3 and 4 cm and has a depression having a volume of 2 cm³, the volume of this “base tablet” is 22 cm³. In this example, the ratio of the volumes is thus 11:1. At tablet: cavity volume ratios below 2:1, which can of course also be realized in accordance with the invention, the instability of the walls can rise.

Similar statements can be made with regard to the surface area fractions which are made up by the tablet with the cavity (“depression tablet”) or the opening surface area of the cavity in the total surface area of the tablet. Preference is given here to laundry detergent and cleaning composition tablets in which the surface area of the opening(s) of the cavity/cavities make(s) up from 1 to 25%, preferably from 2 to 20%, more preferably from 3 to 15% and in particular from 4 to 10%, of the total surface area of the tablet. The total surface area of the tablet corresponds here again to the total surface area of the tablet with “hypothetically closed” cavity, i.e., in the above example, regardless of the opening surface area of the depression, 52 cm². In the case of such an exemplary tablet, in preferred embodiments of the present invention, the opening(s) of the cavity thus has/have a surface area of from 0.52 to 13 cm², preferably from 1.04 to 10.4 cm², more preferably from 1.56 to 7.8 cm² and in particular from 2.08 to 5.2 cm².

The bottom of the depression in the depression tablet may be planar. Planar depression bottoms may run entirely parallel to the incumbent surface of the tablet, but may also be inclined. However, it is also possible to provide a nonplanar depression bottom, for example a concave bottom. This is preferred, since the production of the corresponding depression tablets is better. A compression punch with protruding spike, which is required to produce depression tablets, better displaces the particulate premixture on compression when the spike is not entirely plane-parallel to the compression surface, but rather enables premixture particles to slide away from the pressure zone to the later webs of the depression.

The depression of the depression tablet may be filled with a core. Being the depression filling, the core can virtually fully fill the opening surface area of the depression. However, it is also possible that the core has a distinctly smaller diameter than the opening diameter of the depression. In the context of the present invention, it is preferred that the maximum horizontal cross-sectional surface area of the core makes up from 0.2 to 0.98 times the opening surface area of the depression, preferably from 0.5 to 0.95 times the opening surface area of the depression and in particular from 0.7 to 0.9 times the opening surface area of the depression. The filling of the depression, also referred to as the “core,” is preferably a solid body which can be produced, for example, by casting, sintering, extrusion, calendering, etc. However, it is preferred that the depression filling is a tablet or a casting. Particular preference is given to using, as the filling, cores which have a coating, preferably a multiple coating with two, three, four, five, six or more individual layers. Further solids usable as the filling are pulverulent or granular laundry detergents or cleaning compositions.

The present application therefore further preferably provides a laundry detergent or cleaning composition portion comprising a depression tablet and also a further core present at least partly in the depression of the depression tablet, depression tablet and core being adhesive-bonded to one another by means of a water-soluble melt adhesive comprising from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

As described above, the melt adhesives disclosed at the outset can be used advantageously in processes for producing laundry detergent or cleaning composition portions. The present application therefore further provides a process for producing a laundry detergent or cleaning composition portion by adhesive-bonding at least one constituent of the laundry detergent or cleaning composition portion with a water-soluble melt adhesive which comprises from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

The present application thus further also preferably provides a process for producing a laundry detergent or cleaning composition portion, comprising the steps of
a) production of a (depression) tablet by tableting or casting;
b) adhesive-bonding of the (depression) tablet with a further tablet, preferably a core, by means of a water-soluble melt adhesive which comprises from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

In a further preferred embodiment of the present application, the inventive laundry detergent or cleaning composition portions comprise a water-soluble or water-dispersible packaging. In the context of the present application, “water-soluble or water-dispersible packagings” are in particular water-soluble or water-dispersible films and also bodies produced by injection-molding or bottle-blowing from water-soluble or water-dispersible materials. Such water-soluble or water-dispersible films and also bodies produced by injection-molding or bottle-blowing are preferably used as closure parts for sealing the depressions of the above-described depression tablets.

The present application therefore further preferably provides a laundry detergent or cleaning composition portion comprising a depression tablet and also a water-soluble or water-dispersible closure part which at least partly closes the depression of the depression tablet, depression tablet and closure part being adhesive-bonded to one another by means of a water-soluble melt adhesive which comprises from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

The present application preferably further provides processes for producing a laundry detergent or cleaning composition portion, comprising the steps of
a) production of a depression tablet by tableting or casting;
b) filling the depression of the depression tablet;
c) closing the depression by adhesive-bonding the depression tablet with a water-soluble or water-dispersible closure part by means of a water-soluble melt adhesive which comprises from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

The films used to seal the depressions may be single-layer films but also film laminates. Especially the film laminates are used with particular preference in the context of the present application. For the performance of the sealing, especially for the supply and the cutting-to-size of the films used as the closure part, a series of different processes are possible in the context of the present application.

In a preferred embodiment of the process according to the invention, the sealing film is cut to size after the closure of the depression. The film can be cut to size, for example, by punching, blades or lasers. However, particular preference is given to a process variant in which the sealing film is already present, before the sealing, in the form of prefabricated labels whose size has been adjusted to the size of the depressions of the tablets and which are taken from a reservoir by means of a label applicator and applied to the depressions.

In a further preferred embodiment of the present application, the laundry detergent or cleaning composition portion is entirely surrounded by the water-soluble or water-dispersible packaging. Suitable packaging can be produced, for example, by thermoforming, injection molding or bottle-blowing. However, preference is given to thermoformed or injection-molded packaging.

In the thermoforming process, a first film-like coating material, after being laid over a receiving depression disposed in a die forming the thermoforming plane and shaping of the coating material into this receiving depression, is reshaped by the action of pressure and/or vacuum. The coating material can be pretreated before or during the shaping by the action of heat and/or solvent and/or conditioning by relative atmospheric moisture contents and/or temperatures changed relative to ambient conditions. The action of pressure can be effected by two parts of a tool which behave like positive and negative and shape a film laid between these tools when they are pressed together. However, suitable pressure forces are also the action of compressed air and/or the intrinsic weight of the film and/or the intrinsic weight of an active substance laid on the upper side of the film.

After the thermoforming, the thermoformed coating materials are preferably fixed within the receiving depressions and in their three-dimensional shape achieved by the thermoforming operation by use of a vacuum. The vacuum is applied continuously from the thermoforming up to the charging, preferably up to the sealing and in particular up to the isolation of the receiving chambers.

As already mentioned, the coating material may be pretreated before or during the shaping into the receiving depressions of the dies by the action of heat. The coating material, preferably a water-soluble or water-dispersible polymer film, is heated to temperatures above 60° C., preferably above 80° C., more preferably between 100 and 120° C. and in particular to temperatures between 105 and 115° C. for up to 5 seconds, preferably for from 0.1 to 4 seconds, more preferably for from 0.2 to 3 seconds and in particular for from 0.4 to 2 seconds. To remove this heat, but especially also to remove the heat introduced by the compositions charged into the thermoformed receiving chambers (for example melts), it is preferred to cool the dies used and the receiving depressions present in these dies. The cooling is effected preferably to temperatures below 20° C., preferably below 15° C., more preferably to temperatures between 2 and 14° C. and in particular to temperatures between 4 and 12° C. Preference is given to effecting the cooling continuously from the start of the thermoforming operation up to the sealing and isolation of the receiving chambers. Especially suitable for cooling are cooling liquids, preferably water, which are circulated in special cooling lines within the die.

In the thermoforming processes, it is possible to differentiate between processes in which the coating material is conducted horizontally into a molding station and conducted from there horizontally to the charging and/or sealing and/or isolation, and processes in which the coating material is conducted over a continuous female die shaping roll (if appropriate optionally with a counter-running male die shaping roll, which the demolding upper punches conduct to the cavities of the female die shaping roll). The first-mentioned process variant of the flat bed process can be operated either continuously or batchwise; the process variant using a shaping roll is effected generally continuously. All thermoforming processes mentioned are suitable for producing the compositions preferred in accordance with the invention. The receiving depressions disposed in the dies may be arranged “in series” or offset.

“Injection molding” refers to the reshaping of a molding material such that the material present in a material cylinder for more than one injection-molding operation is softened plastically under the action of heat and flows under pressure through a nozzle into the cavity of a tool closed beforehand. The process is employed mainly in the case of noncurable molding materials which solidify in the tool by cooling. Injection molding is a very economically viable, modern process for producing articles shaped without cutting and is particularly suitable for automated mass production. In industrial operation, the thermoplastic molding materials (powder, particles, cubes, pastes, inter alia) are heated up to liquefaction (up to 180° C.) and then sprayed under high pressure (up to 140 MPa) into closed, two-part, i.e. consisting of die (formerly known as female part) and core (formerly known as male part), preferably water-cooled hollow molds, where they cool and solidify. It is possible to use piston and screw injection-molding machines.

Suitable film materials for thermoforming and suitable molding materials in the injection-molding process are water-soluble polymers, for example the abovementioned cellulose ethers, pectins, polyethylene glycols, polyvinyl alcohols, polyvinylpyrrolidones, alginates, gelatins or starch:

In the context of the present application, preference is therefore further given to inventive laundry detergent or cleaning composition portions comprising a thermoformed or injection-molded receiving vessel composed of a water-soluble or water-dispersible material, laundry detergent or cleaning composition present in this receiving vessel, and also a water-soluble or water-dispersible closure part closing this receiving vessel, receiving vessel and closure part being adhesive-bonded to one another by means of a water-soluble melt adhesive comprising from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

Suitable water-soluble or water-dispersible closure parts are, as already described in the case of the depression tablets described above, especially water-soluble or water-dispersible films but also thermoformed or injection-molded bodies. Particular preference is given to closing the water-soluble or water-dispersible receiving vessels with a closure part in the form of a prefabricated water-soluble or water-dispersible sachet filled with laundry detergent or cleaning composition ingredients.

The present application preferably further provides a process for producing a laundry detergent or cleaning composition portion, comprising the steps of
a) providing a water-soluble or water-dispersible receiving vessel;
b) filling the receiving vessel with washing- or cleaning-active substances;
c) closing the receiving vessel by adhesive-bonding the receiving vessel with a water-soluble or water-dispersible closure part by means of a water-soluble melt adhesive which comprises from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

As already described above for the processes for sealing pressed or cast depression tablets, particular preference is also given to using water-soluble or water-dispersible films for the sealing of the water-soluble or water-dispersible receiving vessels. In a preferred embodiment of the process according to the invention, the sealing film is cut to size after the closure of the depression. The film can be cut to size, for example, by punching, blades or lasers. However, particularly preference is given to a process variant in which the sealing film is already present, before the sealing, in the form of prefabricated labels whose size is adjusted to the size of the depressions of the tablets and which are taken from a reservoir by means of a label applicator and applied to the depressions.

The water-soluble melt adhesives described at the outset made from for the adhesive-bonding or sealing of laundry detergents or cleaning compositions can also be used to produce the film laminates particularly preferred for the packaging of the laundry detergents or cleaning compositions. For this purpose, two or more water-soluble or water-dispersible films are adhesive bonded with one another to give film laminates by means of the water-soluble melt adhesive. In such a process, the melt adhesives serve as laminating agents. The actual lamination operation can be promoted by the use of calendars (roll presses) by the action of pressure.

The present application therefore preferably further provides laundry detergent or cleaning compositions which have laminates composed of water-soluble or water-dispersible films comprising a water-soluble melt adhesive comprising from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives.

The present application further provides for the use of a water-soluble melt adhesive comprising from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives in the production of laundry detergent or cleaning composition portions, preferably for the adhesive-bonding of laundry detergents or cleaning compositions.

Particular preference is given to the use of a water-soluble melt adhesive comprising from 40 to 70% by weight of at least one homo- or copolymer having free carboxylic acid groups based on ethylenically unsaturated monomers (component A), from 15 to 45% by weight of at least one water-soluble or water-dispersible polyurethane (component B) and from 10 to 45% by weight of at least one inorganic or organic base (component C), and also from 0 to 20% by weight of further additives in the formulation of laundry detergents or cleaning compositions, especially for adhesive-bonding solid laundry detergents or cleaning compositions with one another, for adhesive-bonding laundry detergent or cleaning composition tablets with water-soluble or water-dispersible packaging materials, especially water-soluble or water-dispersible films, injection-molded or bottle-blown parts or for adhesive-bonding and sealing water-soluble or water-dispersible thermoformed, injection-molded or bottle-blown receiving vessels filled with laundry detergents or cleaning compositions.

The inventive laundry detergents or cleaning compositions are preferably textile laundry detergents, dishwashing detergents or surface detergents. The group of the textile laundry detergents includes in particular the heavy-duty laundry detergents, color laundry detergents, light-duty laundry detergents, textile softeners or ironing aids. The group of the dishwashing detergents includes the machine dishwasher detergents and machine rinse aids, and also manual dishwashing detergents. The surface detergents include, inter alia, descalers, agents for disinfecting or sterilizing surfaces or articles and agents for cleaning metal or glass surfaces.

The inventive laundry detergents or cleaning compositions comprise one or more washing- or cleaning-active substance(s), preferably one or more constituents from the group of the builders, surfactants, polymers, bleaches, bleach activators, enzymes, dyes, fragrances, electrolytes, pH modifiers, perfume carriers, fluorescers, hydrotropes, foam inhibitors, silicone oils, antiredeposition agents, optical brighteners, graying inhibitors, shrink preventatives, anticrease agents, dye transfer inhibitors, active antimicrobial ingredients, germicides, fungicides, antioxidants, corrosion inhibitors, antistats, ironing aids, repellency and impregnation agents, swelling and antislip agents and/or UV absorbers. These substances will be described in detail below.

Builders

In the context of the present application, the builders include especially the zeolites, silicates, carbonates, organic cobuilders and, where there are no ecological objections to their use, also the phosphates.

Suitable crystalline, sheet-type sodium silicates have the general formula NaMSiₓO₂ₓ₊₁‡≠H₂O where M is sodium or hydrogen, x is a number from 1.9 to 4, y is a number from 0 to 20, and preferred values for x are 2, 3 or 4. Preferred crystalline sheet silicates of the formula specified are those in which M is sodium and x assumes the values of 2 or 3. In particular, preference is given to both β- and also δ-sodium disilicates Na₂Si₂O₅‡≠yH₂O.

It is also possible to use amorphous sodium silicates having an Na₂O:SiO₂ modulus of from 1:2 to 1:3.3, preferably from 1:2 to 1:2.8 and in particular from 1:2 to 1:2.6, which have retarded dissolution and secondary washing properties. The retardation of dissolution relative to conventional amorphous sodium silicates may have been brought about in a variety of ways, for example by surface treatment, compounding, compacting or by overdrying. In the context of this invention, the term morphous also includes—ray-amorphous This means that, in X-ray diffraction experiments, the silicates do not afford any sharp X-ray reflections typical of crystalline substances, but rather yield at best one or more maxima of the scattered X-radiation, which have a width of several degree units of the diffraction angle. However, it may quite possibly lead to even particularly good builder properties if the silicate particles in electron diffraction experiments yield vague or even sharp diffraction maxima. This is to be interpreted such that the products have microcrystalline regions with a size of from 10 to several hundred nm, preference being given to values up to a maximum of 50 nm and in particular up to a maximum of 20 nm. Such X-ray-amorphous silicates likewise have retarded dissolution compared with conventional waterglasses. Special preference is given to compacted amorphous silicates, compounded amorphous silicates and overdried X-ray-amorphous silicates.

In the context of the present invention, it is preferred that these silicate(s), preferably alkali metal silicates, more preferably crystalline or amorphous alkali metal disilicates, are present in laundry detergents or cleaning compositions in amounts of from 10 to 60% by weight, preferably from 15 to 50% by weight and in particular from 20 to 40% by weight, based in each case on the weight of the laundry detergent or cleaning composition.

When the silicates are used as a constituent of machine dishwasher detergents, these compositions preferably comprise at least one crystalline sheet-type silicate of the general formula NaMSiₓO₂ₓ₊₁.yH₂O where M is sodium or hydrogen, x is a number from 1.9 to 22, preferably from 1.9 to 4, and y is a number from 0 to 33. The crystalline sheet-type silicates of the formula NaMSiₓO₂ₓ₊₁.yH₂O are sold, for example, by Clariant GmbH (Germany) under the trade name Na—SKS, for example Na—SKS-1 (Na₂Si₂₂O₄₅.xH₂O, Kenyait), Na—SKS-2 (Na₂Si₁₄O₂₉.xH₂O, Magadiit), Na—SKS-3 (Na₂Si₈O₁₇.xH₂O) or Na—SKS-4 (Na₂Si₄O₉.xH₂O, Makatit).

Particularly suitable for the purposes of the present invention are crystalline sheet silicates of the formula (I) in which x is 2. Among these, suitable in particular are Na—SKS-5 (α-Na₂Si₂O₅), Na—SKS-7 (β-Na₂Si₂O₅, Natrosilit), Na—SKS-9 (NaHSi₂O₅.H₂O), Na—SKS-10 (NaHSi₂O₅.3H₂O, Kanemit), Na—SKS-11 (t-Na₂Si₂O₅) and Na—SKS-13 (NaHSi₂O₅), but in particular Na—SKS-6 (δ-Na₂Si₂O₅).

When the silicates are used as a constituent of machine dishwasher detergents, these compositions in the context of the present application comprise a proportion by weight of the crystalline sheet-type silicate of the formula NaMSiₓO₂ₓ₊₁.yH₂O of from 0.1 to 20% by weight, preferably from 0.2 to 15% by weight and in particular from 0.4 to 10% by weight, based in each case on the total weight of these compositions. It is particularly preferred especially when such machine dishwasher detergents have a total silicate content below 7% by weight, preferably below 6% by weight, preferentially below 5% by weight, more preferably below 4% by weight, even more preferably below 3% by weight and in particular below 2.5% by weight, this silicate, based on the total weight of the silicate present, being silicate of the general formula NaMSiₓO₂ₓ₊₁.yH₂O preferably to an extent of at least 70% by weight, preferentially to an extent of at least 80% by weight and in particular to an extent of at least 90% by weight.

The finely crystalline, synthetic, bound water-containing zeolite used is preferably zeolite A and/or P. The zeolite P is more preferably Zeolite MAP® (commercial product from Crosfield). Also suitable, however, are zeolite X, and mixtures of A, X and/or P. Also commercially available and usable with preference in accordance with the present invention is, for example, a cocrystal of zeolite X and zeolite A (approx. 80% by weight of zeolite X), which is sold by CONDEA Augusta S.p.A. under the trade name VEGOBOND AX® and can be described by the formula
nNa₂O.(1−n)K₂O.Al₂O₃.(2−2.5)SiO₂.(3.5−5.5)H₂O.
The zeolite may be used either as a builder in a granular compound or in a kind of “powdering” of the entire mixture to be compacted, and both ways of incorporating the zeolite into the premixture are typically utilized. Suitable zeolites have an average particle size of less than 10 μm (volume distribution; measurement method: Coulter Counter) and preferably contain from 18 to 22% by weight, in particular from 20 to 22% by weight, of bound water.

It is of course also possible to use the commonly known phosphates as builder substances, as long as such a use is not to be avoided for ecological reasons. This is especially true for the use of inventive compositions as machine dishwasher detergents, which is particularly preferred in the context of the present application. Among the multitude of commercially available phosphates, the alkali metal phosphates, with particular preference for pentasodium triphosphate or pentapotassium triphosphate (sodium tripolyphosphate or potassium tripolyphosphate), have the greatest significance in the laundry detergents and cleaning products industry.

Alkali metal phosphates is the collective term for the alkali metal (especially sodium and potassium) salts of the various phosphoric acids, for which a distinction may be drawn between metaphosphoric acids (HPO₃)ₙ and orthophosphoric acid H₃PO₄, in addition to higher molecular weight representatives. The phosphates combine a number of advantages: they act as alkali carriers, prevent limescale deposits on machine components and lime encrustations in fabrics, and additionally contribute to the cleaning performance.

Suitable phosphates are, for example, sodium dihydrogen-phosphate, NaH₂PO₄, in the form of the dihydrate (density 1.91 gcm⁻³, melting point 60−) or in the form of the monohydrate (density 2.04 gcm⁻³), disodium hydrogen-phosphate (secondary sodium phosphate), Na₂HPO₄, which is in anhydrous form or can be used with 2 mol of water (density 2.066 gcm⁻³, loss of water at 95−), 7 mol of water (density 1.68 gcm⁻³, melting point 48− with loss of 5 H₂O) and 12 mol of water (density 1.52 gcm⁻³, melting point 35− with loss of 5 H₂0), but in particular trisodium phosphate (tertiary sodium phosphate) Na₃PO₄, which can be used as the dodecahydrate, as the decahydrate (corresponding to 19-20% P₂O₅) and in anhydrous form (corresponding to 39-40% P₂O₅).

A further preferred phosphate is tripotassium phosphate (tertiary or tribasic potassium phosphate), K₃PO₄. Preference is further given to tetrasodium diphosphate (sodium pyrophosphate), Na₄P₂O₇, which exists in anhydrous form (density 2.534 gcm⁻³, melting point 988−, 880− also reported) and as the decahydrate (density 1.815-1.836 gcm⁻³, melting point 94− with loss of water), and also the corresponding potassium salt, potassium diphosphate (potassium pyrophosphate), K₄P₂O₇.

Condensation of NaH₂PO₄ or of KH₂PO₄ gives rise to higher molecular weight sodium phosphates and potassium phosphates, for which a distinction can be drawn between cyclic representatives, the sodium metaphosphates and potassium metaphosphates, and catenated types, the sodium polyphosphates and potassium polyphosphates. For the latter in particular a multitude of names are in use: fused or calcined phosphates, Graham salt, Kurrol salt and Maddrell salt. All higher sodium and potassium phosphates are referred to collectively as condensed phosphates.

The industrially important pentasodium triphosphate, Na₅P₃O₁₀ (sodium tripolyphosphate), is a nonhygroscopic, white, water-soluble salt which is anhydrous or crystallizes with 6 H₂O and has the general formula NaO—[P(O)(ONa)—O]ₙ—Na where n=3. The corresponding potassium salt, pentapotassium triphosphate, K₅P₃O₁₀ (potassium tripolyphosphate), is available commercially, for example, in the form of a 50% by weight solution (>23% P₂O₅, 25% K₂O). The potassium polyphosphates find wide use in the laundry detergents and cleaning compositions industry. There also exist sodium potassium tripolyphosphates which can likewise be used in the context of the present invention. They are formed, for example, when sodium trimetaphosphate is hydrolyzed with KOH:
(NaPO₃)₃+2 KOH→Na₃K₂P₃O₁₀+H₂O
They can be used in accordance with the invention in precisely the same way as sodium tripolyphosphate, potassium tripolyphosphate or mixtures of the two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used in accordance with the invention.

When phosphates are used as washing- or cleaning-active substances in laundry detergents or cleaning compositions in the context of the present application, preferred compositions comprise these phosphate(s), preferably alkali metal phosphate(s), more preferably pentasodium triphosphate or pentapotassium triphosphate (sodium tripolyphosphate or potassium tripolyphosphate), in amounts of from 5 to 80% by weight, preferably from 15 to 75% by weight and in particular from 20 to 70% by weight, based in each case on the weight of the laundry detergent or cleaning composition.

It is especially preferred to use potassium tripolyphosphate and sodium tripolyphosphate in a weight ratio of more than 1:1, preferably more than 2:1, preferentially more than 5:1, more preferably more than 10:1 and especially more than 20:1. It is particularly preferred to use exclusively potassium tripolyphosphate without additions of other phosphates.

Further builders are the alkali carriers. Alkali carriers include, for example, alkali metal hydroxides, alkali metal carbonates, alkali metal hydrogencarbonates, alkali metal sesquicarbonates, the aforementioned alkali metal silicates, alkali metal metasilicates and mixtures of the aforementioned substances, preference being given in the context of this invention to using the alkali metal carbonates, especially sodium carbonate, sodium hydrogencarbonate or sodium sesquicarbonate. Particular preference is given to a builder system comprising a mixture of tripolyphosphate and sodium carbonate. Particular preference is likewise given to a builder system comprising a mixture of tripolyphosphate and sodium carbonate and sodium disilicate. Owing to their low chemical compatibility with the remaining ingredients of laundry detergents or cleaning compositions in comparison with other builder substances, the alkali metal hydroxides are preferably used only in small amounts, preferably in amounts below 10% by weight, preferentially below 6% by weight, more preferably below 4% by weight and in particular below 2% by weight, based in each case on the total weight of the laundry detergent or cleaning composition. Particular preference is given to compositions which, based on their total weight, contain less than 0.5% by weight of and in particular no alkali metal hydroxides.

Particular preference is given to the use of carbonate(s) and/or hydrogencarbonate(s), preferably alkali metal carbonates, more preferably sodium carbonate, in amounts of from 2 to 50% by weight, preferably from 5 to 40% by weight and in particular from 7.5 to 30% by weight, based in each case on the weight of the laundry detergent or cleaning composition. Particular preference is given to compositions which, based on the weight of the laundry detergent or cleaning composition (i.e. the total weight of the combination product without packaging), contain less than 20% by weight, preferably less than 17% by weight, preferentially less than 13% by weight and in particular less than 9% by weight of carbonate(s) and/or hydrogencarbonate(s), preferably alkali metal carbonates, more preferably sodium carbonate.

Organic cobuilders include in particular polycarboxylates/polycarboxylic acids, polymeric polycarboxylates, aspartic acid, polyacetals, dextrins, further organic cobuilders (see below) and phosphonates. These substance classes are described below.

Organic builder substances which can be used are, for example, the polycarboxylic acids usable in the form of their sodium salts, polycarboxylic acids referring to those carboxylic acids which bear more than one acid function. Examples of these are citric acid, adipic acid, succinic acid, glutaric acid, malic acid, tartaric acid, maleic acid, fumaric acid, sugar acids, aminocarboxylic acids, nitrilotriacetic acid (NTA), as long as such a use is not objectionable on ecological grounds, and mixtures thereof. Preferred salts are the salts of the polycarboxylic acids such as citric acid, adipic acid, succinic acid, glutaric acid, tartaric acid, sugar acids and mixtures thereof.

The acids themselves may also be used. In addition to their builder action, the acids typically also have the property of an acidifying component and thus also serve to set a lower and milder pH of laundry detergents and cleaning compositions. In this connection, particular mention should be made of citric acid, succinic acid, glutaric acid, adipic acid, gluconic acid and any mixtures thereof.

Also suitable as builders are polymeric polycarboxylates; these are, for example, the alkali metal salts of polyacrylic acid or of polymethacrylic acid, for example those having a relative molecular mass of from 500 to 70 000 g/mol.

In the context of this document, the molar masses specified for polymeric polycarboxylates are weight-average molar masses M_{W} of the particular acid form, which has always been determined by means of gel-permeation chromatography (GPC) using a UV detector. The measurement was against an external polyacrylic acid standard which, owing to its structural similarity to the polymers under investigation, provides realistic molecular weight values. These figures deviate considerably from the molecular weight data when polystyrenesulfonic acids are used as the standard. The molar masses measured against polystyrenesulfonic acids are generally distinctly higher than the molar masses specified in this document.

Suitable polymers are in particular polyacrylates which preferably have a molecular mass of from 2000 to 20 000 g/mol. Owing to their superior solubility, preference within this group may be given in turn to the short-chain polyacrylates which have molar masses of from 2000 to 10 000 g/mol and more preferably from 3000 to 5000 g/mol.

Also suitable are copolymeric polycarboxylates, especially those of acrylic acid with methacrylic acid and of acrylic acid or methacrylic acid with maleic acid. Copolymers which have been found to be particularly suitable are those of acrylic acid with maleic acid which contain from 50 to 90% by weight of acrylic acid and from 50 to 10% by weight of maleic acid. Their relative molecular mass, based on free acids, is generally from 2000 to 70 000 g/mol, preferably from 20 000 to 50 000 g/mol and in particular from 30 000 to 40 000 g/mol.

The (co)polymeric polycarboxylates can either be used in the form of powders or in the form of aqueous solutions. The (co)polymeric polycarboxylate content of the laundry detergents or cleaning compositions is preferably from 0.5 to 20% by weight, in particular from 3 to 10% by weight.

To improve the water solubility, the polymers may also contain allylsulfonic acids, for example allyloxybenzenesulfonic acid and methallylsulfonic acid, as monomers.

Also especially preferred are biodegradable polymers composed of more than two different monomer units, for example those which contain, as monomers, salts of acrylic acid and of maleic acid, and vinyl alcohol or vinyl alcohol derivatives, or those which contain, as monomers, salts of acrylic acid and of 2-alkylallylsulfonic acid, and sugar derivatives.

Further preferred copolymers are those which preferably have, as monomers, acrolein and acrylic acid/acrylic acid salts or acrolein and vinyl acetate.

Further preferred builder substances which should likewise be mentioned are polymeric aminodicarboxylic acids, salts thereof or precursor substances thereof. Particular preference is given to polyaspartic acids or salts thereof.

Further suitable builder substances are polyacetals which can be obtained by reacting dialdehydes with polyolcarboxylic acids which have from 5 to 7 carbon atoms and at least 3 hydroxyl groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out by customary, for example acid-catalyzed or enzyme-catalyzed, processes. The hydrolysis products preferably have average molar masses in the range from 400 to 500 000 g/mol. Preference is given to a polysaccharide having a dextrose equivalent (DE) in the range from 0.5 to 40, in particular from 2 to 30, where DE is a common measure of the reducing action of a polysaccharide compared to dextrose, which has a DE of 100. It is also possible to use maltodextrins with a DE between 3 and 20 and dry glucose syrups with a DE between 20 and 37, and also yellow dextrins and white dextrins having relatively high molar masses in the range from 2000 to 30 000 g/mol.

The oxidized derivatives of such dextrins are their reaction products with oxidizing agents which are capable of oxidizing at least one alcohol function of the saccharide ring to the carboxylic acid function.

Oxydisuccinates and other derivatives of disuccinates, preferably ethylenediaminedisuccinate, are also further suitable cobuilders. In this case, ethylenediamine-N,N′-disuccinate (EDDS) is preferably used in the form of its sodium or magnesium salts. Furthermore, in this connection, preference is also given to glyceryl disuccinates and glyceryl trisuccinates. Suitable use amounts in zeolite-containing and/or silicate-containing formulations are from 3 to 15% by weight.

Further organic cobuilders which can be used are, for example, acetylated hydroxycarboxylic acids or salts thereof, which may also be present in lactone form and which contain at least 4 carbon atoms and at least one hydroxyl group and a maximum of two acid groups.

A further class of substances having cobuilder properties is that of the phosphonates. These are in particular hydroxyalkane- and aminoalkanephosphonates. Among the hydroxyalkanephosphonates, 1-hydroxyethane-1,1-diphosphonate (HEDP) is of particular significance as a cobuilder. It is preferably used in the form of the sodium salt, the disodium salt giving a neutral reaction and the tetrasodium salt an alkaline reaction (pH 9). Useful aminoalkanephosphonates are preferably ethylenediaminetetramethylene-phosphonate (EDTMP), diethylenetriaminepentamethylenephosphonate (DTPMP) and higher homologs thereof. They are preferably used in the form of the neutrally reacting sodium salts, for example as the hexasodium salt of EDTMP or as the hepta- and octasodium salt of DTPMP. From the class of the phosphonates, preference is given to using HEDP as a builder. In addition, the aminoalkanephosphonates have a marked heavy metal-binding capacity. Accordingly, especially when the compositions also comprise bleaches, it may be preferable to use aminoalkanephosphonates, especially DTPMP, or mixtures of the phosphonates mentioned.

In addition, it is possible to use all compounds which are capable of forming complexes with alkaline earth metal ions as builders.

Surfactants

The group of the surfactants includes not only the nonionic surfactants but also the anionic, cationic and amphoteric surfactants.

The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohols having 3 EO, 5 EO or 7 EO an mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

In addition, further nonionic surfactants which may be used are also alkyl glycosides of the general formula RO(G)ₓ in which R is a primary straight-chain or methyl-branched, in particular 2-methyl-branched, aliphatic radical having from 8 to 22, preferably from 12 to 18, carbon atoms and G is the symbol which is a glycose unit having 5 or 6 carbon atoms, preferably glucose. The degree of oligomerization x, which specifies the distribution of monoglycosides and oligoglycosides, is any number between 1 and 10; x is preferably from 1.2 to 1.4.

A further class of nonionic surfactants used with preference, which are used either as the sole nonionic surfactant or in combination with other nonionic surfactants, are alkoxylated, preferably ethoxylated or ethoxylated and propoxylated, fatty acid alkyl esters, preferably having from 1 to 4 carbon atoms in the alkyl chain.

Nonionic surfactants of the amine oxide type, for example N-cocoalkyl-N,N-dimethylamine oxide and N-tallow alkyl-N,N-dihydroxyethylamine oxide, and of the fatty acid alkanolamide type may also be suitable. The amount of these nonionic surfactants is preferably not more than that of the ethoxylated fatty alcohols, in particular not more than half thereof.

Further suitable surfactants are polyhydroxy fatty acid amides of the formula (I) 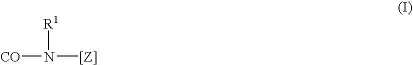
in which RCO is an aliphatic acyl radical having from 6 to 22 carbon atoms, R¹ is hydrogen, an alkyl or hydroxyalkyl radical having from 1 to 4 carbon atoms and [Z] is a linear or branched polyhydroxyalkyl radical having from 3 to 10 carbon atoms and from 3 to 10 hydroxyl groups. The polyhydroxy fatty acid amides are known substances which can typically be obtained by reductively aminating a reducing sugar with ammonia, an alkylamine or an alkanolamine, and subsequently acylating with a fatty acid, a fatty acid alkyl ester or a fatty acid chloride.

The group of polyhydroxy fatty acid amides also includes compounds of the formula 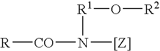
in which R is a linear or branched alkyl or alkenyl radical having from 7 to 12 carbon atoms, R¹ is a linear, branched or cyclic alkyl radical or an aryl radical having from 2 to 8 carbon atoms and R² is a linear, branched or cyclic alkyl radical or an aryl radical or an oxyalkyl radical having from 1 to 8 carbon atoms, preference being given to C₁₋₄-alkyl or phenyl radicals, and [Z] is a linear polyhydroxyalkyl radical whose alkyl chain is substituted by at least two hydroxyl groups, or alkoxylated, preferably ethoxylated or propoxylated, derivatives of this radical.

[Z] is preferably obtained by reductive amination of a reduced sugar, for example glucose, fructose, maltose, lactose, galactose, mannose or xylose. The N-alkoxy- or N-aryloxy-substituted compounds can be converted to the desired polyhydroxy fatty acid amides by reaction with fatty acid methyl esters in the presence of an alkoxide as catalyst.

The surfactants used with preference are low-foaming nonionic surfactants. With particular preference, the inventive cleaning compositions for machine dishwashing comprise nonionic surfactants, in particular nonionic surfactants from the group of the alkoxylated alcohols. The nonionic surfactants used are preferably alkoxylated, advantageously ethoxylated, in particular primary alcohols having preferably from 8 to 18 carbon atoms and on average from 1 to 12 mol of ethylene oxide (EO) per mole of alcohol in which the alcohol radical may be linear or preferably 2-methyl-branched, or may contain a mixture of linear and methyl-branched radicals, as are typically present in oxo alcohol radicals. However, especially preferred alcohol ethoxylates have linear radicals of alcohols of natural origin having from 12 to 18 carbon atoms, for example of coconut, palm, tallow fat or oleyl alcohol, and on average from 2 to 8 EO per mole of alcohol. The preferred ethoxylated alcohols include, for example, C₁₂₋₁₄-alcohols having 3 EO or 4 EO, C₉₋₁₁-alcohol having 7 EO, C₁₃₋₁₅-alcohols having 3 EO, 5 EO, 7 EO or 8 EO, C₁₂₋₁₈-alcohol 5 EO or 7 EO and mixtures thereof, such as mixtures of C₁₂₋₁₄-alcohol having 3 EO and C₁₂₋₁₈-alcohol having 5 EO. The degrees of ethoxylation specified are statistical average values which may be an integer or a fraction for a specific product. Preferred alcohol ethoxylates have a narrowed homolog distribution (narrow range ethoxylates, NRE). In addition to these nonionic surfactants, it is also possible to use fatty alcohols having more than 12 EO. Examples thereof are tallow fatty alcohol having 14 EO, 25 EO, 30 EO or 40 EO.

Special preference is given to nonionic surfactants which have a melting point above room temperature, particular preference being given to nonionic surfactants having a melting point above 20° C., preferably above 25° C., more preferably between 25 and 60° C. and in particular between 26.6 and 43.3° C.

Suitable nonionic surfactants which have melting or softening points in the temperature range specified are, for example, low-foaming nonionic surfactants which may be solid or highly viscous at room temperature. When nonionic surfactants which have a high viscosity at room temperature are used, they preferably have a viscosity above 20 Pas, preferably above 35 Pas and in particular above 40 Pas. Nonionic surfactants which have a waxlike consistency at room temperature are also preferred.

Nonionic surfactants which are solid at room temperature and are to be used with preference stem from the group of alkoxylated nonionic surfactants, in particular the ethoxylated primary alcohols and mixtures of these surfactants with structurally complex surfactants, such as polyoxypropylene/polyoxyethylene/polyoxypropylene (PO/EO/PO) surfactants. Such (PO/EO/PO) nonionic surfactants are additionally notable for good foam control.

In a preferred embodiment of the present invention, the nonionic surfactant with a melting point above room temperature is an ethoxylated nonionic surfactant which has resulted from the reaction of a monohydroxyalkanol or alkylphenol having from 6 to 20 carbon atoms with preferably at least 12 mol, more preferably at least 15 mol, in particular at least 20 mol, of ethylene oxide per mole of alcohol or alkylphenol.

A nonionic surfactant which is solid at room temperature and is to be used with particular preference is obtained from a straight-chain fatty alcohol having from 16 to 20 carbon atoms (C₁₆₋₂₀-alcohol), preferably a C₁₈-alcohol, and at least 12 mol, preferably at least 15 mol and in particular at least 20 mol, of ethylene oxide. Of these, the “narrow range ethoxylates” (see above) are particularly preferred.

Accordingly, particular preference is given to ethoxylated nonionic surfactants which have been obtained from C₆₋₂₀-monohydroxyalkanols or C₆₋₂₀-alkylphenols or C₁₆₋₂₀-fatty alcohols and more than 12 mol, preferably more than 15 mol and in particular more than 20 mol of ethylene oxide per mole of alcohol.

The room temperature solid nonionic surfactant preferably additionally has propylene oxide units in the molecule. Preferably, such PO units make up up to 25% by weight, more preferably up to 20% by weight and in particular up to 15% by weight, of the total molar mass of the nonionic surfactant. Particularly preferred nonionic surfactants are ethoxylated monohydroxyalkanols or alkylphenols which additionally have polyoxyethylene-polyoxypropylene block copolymer units. The alcohol or alkylphenol moiety of such nonionic surfactant molecules preferably makes up more than 30% by weight, more preferably more than 50% by weight and in particular more than 70% by weight, of the total molar mass of such nonionic surfactants. Preferred dishwasher detergents are characterized in that they comprise ethoxylated and propoxylated nonionic surfactants in which the propylene oxide units in the molecule make up up to 25% by weight, preferably up to 20% by weight and in particular up to 15% by weight, of the total molar mass of the nonionic surfactant.

Further nonionic surfactants which have melting points above room temperature and are to be used with particular preference contain from 40 to 70% of a polyoxypropylene/polyoxyethylene/polyoxypropylene block polymer blend which contains 75% by weight of an inverse block copolymer of polyoxyethylene and polyoxypropylene having 17 mol of ethylene oxide and 44 mol of propylene oxide, and 25% by weight of a block copolymer of polyoxyethylene and polyoxypropylene initiated with trimethylolpropane and containing 24 mol of ethylene oxide and 99 mol of propylene oxide per mole of trimethylolpropane.

Nonionic surfactants which can be used with particular preference are obtainable, for example, under the name Poly Tergent® SLF-18 from Olin Chemicals.

In laundry detergents or cleaning compositions, preferably in dishwasher detergents, use is made of the nonionic surfactant of the formula (II)
R¹O[CH₂CH(CH₃)O]ₓ[CH₂CH₂O]_{y}[CH₂CH(OH)R²] (II)
in which R¹ is a linear or branched aliphatic hydrocarbon radical having from 4 to 18 carbon atoms or mixtures thereof, R² is a linear or branched hydrocarbon radical having from 2 to 26 carbon atoms or mixtures thereof, and x is a value between 0.5 and 1.5, and y is a value of at least 15.

Further nonionic surfactants which can be used with preference are the terminally capped poly(oxyalkylated) nonionic surfactants of the formula
R¹O[CH₂CH(R³)O]ₓ[CH₂]ₖCH(OH)[CH₂]ⱼOR²

in which R¹ and R² are linear or branched, saturated or unsaturated, aliphatic or aromatic hydrocarbon radicals having from 1 to 30 carbon atoms, R³is H or a methyl, ethyl, n-propyl, isopropyl, n-butyl, 2-butyl or 2-methyl-2-butyl radical, x is a value between 1 and 30, k and j are values between 1 and 12, preferably between 1 and 5. When the value x is ≧2, each R³ in the above formula may be different. R¹ and R² are preferably linear or branched, saturated or unsaturated, aliphatic or aromatic hydrocarbon radicals having from 6 to 22 carbon atoms, particular preference being given to radicals having from 8 to 18 carbon atoms. For the R³ radical, particular preference is given to H, —CH₃ or —CH₂CH₃. Particularly preferred values for x are in the range from 1 to 20, in particular from 6 to 15.

As described above, each R³ in the above formula may be different if x is ≧2. This allows the alkylene oxide unit in the square brackets to be varied. When x is, for example, 3, the R³ radical may be selected so as to form ethylene oxide (R³═H) or propylene oxide (R³═CH₃) units which can be joined together in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and it is entirely possible for it to be larger, the scope of variation increasing with increasing x values and embracing, for example, a large number of (EO) groups combined with a small number of (PO) groups, or vice versa.

Especially preferred terminally capped poly(oxyalkylated) alcohols of the above formula have values of k=1 and j=1, so that the above formula is simplified to
R¹O[CH₂CH(R³)O]ₓCH₂CH(OH)CH₂OR².
In the latter formula, R¹, R² and R³ are each as defined above and x is a number from 1 to 30, preferably from 1 to 20 and in particular from 6 to 18. Particular preference is given to surfactants in which the R¹ and R² radicals have from 9 to 14 carbon atoms, R³ is H and x assumes values of from 6 to 15.

If the latter statements are summarized, preference is given to the terminally capped poly(oxyalkylated) nonionic surfactants of the formula
R¹O[CH₂CH(R³)O]ₓ[CH₂]ₖCH(OH)[CH₂]ⱼOR²
in which R¹ and R² are linear or branched, saturated or unsaturated, aliphatic or aromatic hydrocarbon radicals having from 1 to 30 carbon atoms, R³ is H or a methyl, ethyl, n-propyl, isopropyl, n-butyl, 2-butyl or 2-methyl-2-butyl radical, x is a value between 1 and 30, k and j are values between 1 and 12, preferably between 1 and 5, particular preference being given to surfactants of the
R¹O[CH₂CH(R³)O]ₓCH₂CH(OH)CH₂OR²
type in which x is a number from 1 to 30, preferably from 1 to 20 and in particular from 6 to 18.

Particularly preferred nonionic surfactants in the context of the present invention have been found to be low-foaming nonionic surfactants which have alternating ethylene oxide and alkylene oxide units. Among these, preference is given in turn to surfactants having EO-AO-EO-AO blocks, and in each case from 1 to 10 EO and/or AO groups are bonded to one another before a block of the other groups in each case follows. Preference is given here to inventive machine dishwasher detergents which comprise, as nonionic surfactant(s), surfactants of the general formula III 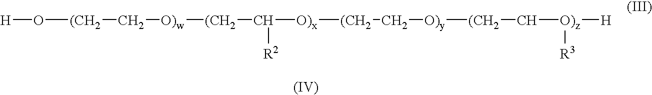
in which R¹ is a straight-chain or branched, saturated or mono- or polyunsaturated C₆₋₂₄-alkyl or -alkenyl radical; each R² or R³ group is independently selected from —CH₃; —CH₂CH₃, —CH₂CH₂—CH₃, CH(CH₃)₂ and the indices w, x, y, z are each independently integers from 1 to 6.

The preferred nonionic surfactants of the formula III can be prepared by known methods from the corresponding alcohols R¹—OH and ethylene oxide or alkylene oxide. The R¹ radical in the above formula III may vary depending on the origin of the alcohol. When native sources are utilized, the R¹ radical has an even number of carbon atoms and is generally unbranched, and preference is given to the linear radicals of alcohols of native origin having from 12 to 18 carbon atoms, for example from coconut, palm, tallow fat or oleyl alcohol. Alcohols obtainable from synthetic sources are, for example, the Guerbet alcohols or 2-methyl-branched or linear and methyl-branched radicals in a mixture, as are typically present in oxo alcohol radicals. Irrespective of the type of the alcohol used to prepare the nonionic surfactants present in accordance with the invention in the products, preference is given to inventive machine dishwasher detergents in which R¹ in formula III is an alkyl radical having from 6 to 24, preferably from 8 to 20, more preferably from 9 to 15 and in particular from 9 to 11 carbon atoms.

The alkylene oxide unit which is present in the preferred nonionic surfactants in alternation to the ethylene oxide unit is, as well as propylene oxide, especially butylene oxide. However, further alkylene oxides in which R² and R³ are each independently selected from —CH₂CH₂—CH₃ and CH(CH₃)₂ are also suitable. Preferred machine dishwasher detergents are characterized in that R² and R³ are each a —CH₃ radical, w and x are each independently 3 or 4, and y and z are each independently 1 or 2.

In summary, preference is given in particular to nonionic surfactants which have a C₉₋₁₅-alkyl radical having from 1 to 4 ethylene oxide units, followed by from 1 to 4 propylene oxide units, followed by from 1 to 4 ethylene oxide units, followed by from 1 to 4 propylene oxide units. In aqueous solution, these surfactants have the required low viscosity and can be used with particular preference in accordance with the invention.

Further nonionic surfactants usable with preference are the terminally capped poly(oxyalkylated)nonionic surfactants of the formula (IV)
R¹O[CH₂CH(R³)O]ₓR² (IV)
in which R¹ is linear or branched, saturated or unsaturated, aliphatic or aromatic hydrocarbon radicals having from 1 to 30 carbon atoms, R² is linear or branched, saturated or unsaturated, aliphatic or aromatic hydrocarbon radicals having from 1 to 30 carbon atoms and preferably have between 1 and 5 hydroxyl groups and are preferably further functionalized with an ether group, R³ is H or a methyl, ethyl, n-propyl, isopropyl, n-butyl, 2-butyl or 2-methyl-2-butyl radical, x is values between 1 and 40.

In particularly preferred nonionic surfactants of the above formula (IV), R³ is H. In the resulting terminally capped poly(oxyalkylated) nonionic surfactants of the formula (V)
R¹O[CH₂CH₂O]ₓR² (V)
preference is given in particular to those nonionic surfactants in which R¹ is linear or branched, saturated or unsaturated, aliphatic or aromatic hydrocarbon radicals having from 1 to 30 carbon atoms, preferably having from 4 to 20 carbon atoms, R² is linear or branched, saturated or unsaturated, aliphatic or aromatic hydrocarbon radicals having from 1 to 30 carbon atoms and preferably have between 1 and 5 hydroxyl groups, and x is values between 1 and 40.

Preference is given in particular to those terminally capped poly(oxyalkylated) nonionic surfactants which, according to the formula (VI)
R¹O[CH₂CH₂O]ₓCH₂CH(OH)R² (VI)
have not only an R¹ radical which is linear or branched, saturated or unsaturated, aliphatic or aromatic hydrocarbon radicals having from 1 to 30 carbon atoms, preferably having from 4 to 20 carbon atoms, but also a linear or branched, saturated or unsaturated, aliphatic or aromatic hydrocarbon radical having from 1 to 30 carbon atoms R² which is adjacent to a monohydroxylated intermediate group —CH₂CH(OH)—. In this formula, x is values between 1 and 40. Such terminally capped poly(oxyalkylated) nonionic surfactants can be obtained, for example, by reacting a terminal epoxide of the formula R²CH(O)CH₂ with an ethoxylated alcohol of the formula R¹O[CH₂CH₂O]ₓ₋₁CH₂CH₂OH.

The specified carbon chain lengths and degrees of ethoxylation or degrees of alkoxylation of the aforementioned nonionic surfactants constitute statistical averages which may be a whole number or a fraction for a specific product. As a consequence of the preparation process, commercial products of the formulae specified do not usually consist of one individual representative, but rather of mixtures, as a result of which average values and consequently fractions can arise both for the carbon chain lengths and for the degrees of ethoxylation or degrees of alkoxylation.

The anionic surfactants used are, for example, those of the sulfonate and sulfate type. Useful surfactants of the sulfonate type are preferably C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products. Also suitable are alkanesulfonates which are obtained from C₁₂₋₁₈-alkanes, for example by sulfochlorination or sulfoxidation with subsequent hydrolysis or neutralization. The esters of α-sulfo fatty acids (ester sulfonates), for example the α-sulfonated methyl esters of hydrogenated coconut, palm kernel or tallow fatty acids, are also likewise suitable.

Further suitable anionic surfactants are sulfated fatty acid glycerol esters. Fatty acid glycerol esters refer to the mono-, di- and triesters, and mixtures thereof, as are obtained in the preparation by esterification of a monoglycerol with from 1 to 3 mol of fatty acid or in the transesterification of triglycerides with from 0.3 to 2 mol of glycerol. Preferred sulfated fatty acid glycerol esters are the sulfation products of saturated fatty acids having from 6 to 22 carbon atoms, for example of caproic acid, caprylic acid, capric acid, myristic acid, lauric acid, palmitic acid, stearic acid or behenic acid.

Preferred alk(en)yl sulfates are the alkali metal and in particular the sodium salts of the sulfuric monoesters of C₁₂-C₁₈ fatty alcohols, for example of coconut fatty alcohol, tallow fatty alcohol, lauryl, myristyl, cetyl or stearyl alcohol, or of C₁₀-C₂₀ oxo alcohols and those monoesters of secondary alcohols of these chain lengths. Also preferred are alk(en)yl sulfates of the chain length mentioned which contain a synthetic straight-chain alkyl radical prepared on a petrochemical basis and which have analogous degradation behavior to the equivalent compounds based on fatty chemical raw materials. From the washing point of view, preference is given to the C₁₂-C₁₆-alkyl sulfates and C₁₂-C₁₅-alkyl sulfates, and C₁₄-C₁₅-alkyl sulfates. 2,3-Alkyl sulfates, which can be obtained as commercial products from the Shell Oil Company under the name DAN®, are also suitable anionic surfactants.

Also suitable are the sulfuric monoesters of the straight-chain or branched C₇₋₂₁-alcohols ethoxylated with 1 to 6 mol of ethylene oxide, such as 2-methyl-branched C₉₋₁₁-alcohols with on average 3.5 mol of ethylene oxide (EO) or C₁₂-,₈-fatty alcohols with from 1 to 4 EO. Owing to their high tendency to foam, they are used in detergents only in relatively small amounts, for example amounts of from 1 to 5% by weight.

Further suitable anionic surfactants are also the salts of alkylsulfosuccinic acid, which are also referred to as sulfosuccinates or as sulfosuccinic esters and are the monoesters and/or diesters of sulfosuccinic acid with alcohols, preferably fatty alcohols and in particular ethoxylated fatty alcohols. Preferred sulfosuccinates contain C₈₋₁₈ fatty alcohol radicals or mixtures thereof. Especially preferred sulfosuccinates contain a fatty alcohol radical which is derived from ethoxylated fatty alcohols which, considered alone, constitute nonionic surfactants (for description see below). In this context, particular preference is again given to sulfosuccinates whose fatty alcohol radicals are derived from ethoxylated fatty alcohols with a narrowed homolog distribution. It is also equally possible to use alk(en)ylsuccinic acid having preferably from 8 to 18 carbon atoms in the alk(en)yl chain or salts thereof.

Useful further anionic surfactants are in particular soaps. Suitable soaps are saturated fatty acid soaps, such as the salts of lauric acid, myristic acid, palmitic acid, stearic acid, hydrogenated erucic acid and behenic acid, and soap mixtures derived in particular from natural fatty acids, for example coconut, palm kernel or tallow fatty acids.

The anionic surfactants including the soaps may be present in the form of their sodium, potassium or ammonium salts, and also in the form of soluble salts of organic bases, such as mono-, di- or triethanolamine. The anionic surfactants are preferably present in the form of their sodium or potassium salts, in particular in the form of the sodium salts.

When the anionic surfactants are a constituent of machine dishwasher detergents, their content, based on the total weight of the compositions, is preferably less than 4% by weight, preferentially less than 2% by weight and most preferably less than 1% by weight. Special preference is given to machine dishwasher detergents which do not contain any anionic surfactants.

Instead of the surfactants mentioned or in conjunction with them, it is also possible to use cationic and/or amphoteric surfactants.

As cationic active substances, the inventive compositions may, for example, comprise cationic compounds of the formulae VII, VIII or IX: 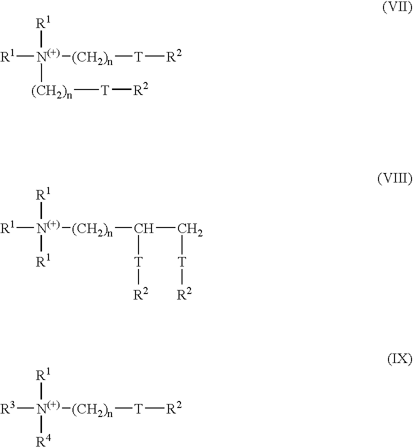
in which each R¹ group is independently selected from C₁₋₆-alkyl, -alkenyl or -hydroxyalkyl groups; each R² group is independently selected from C₈₋₂₈-alkyl or -alkenyl groups; R³═R¹ or (CH₂)ₙ-T-R²; R⁴═R^{1 or R}² or (CH₂)ₙ-T-R²; T=—CH₂—, —O—CO— or —CO—O— and n is an integer from 0 to 5.

In machine dishwasher detergents, the content of cationic and/or amphoteric surfactants is preferably less than 6% by weight, preferentially less than 4% by weight, even more preferably less than 2% by weight and in particular less than 1% by weight. Particular preference is given to machine dishwasher detergents which do not contain any cationic or amphoteric surfactants.

Polymers

The group of polymers includes in particular the washing- or cleaning-active polymers, for example the rinse aid polymers and/or polymers active as softeners. Generally, not only nonionic polymers but also cationic, anionic and amphoteric polymers can be used in laundry detergents and cleaning compositions.

Polymers effective as softeners are, for example, the polymers containing sulfonic acid groups, which are used with particular preference.

Polymers which contain suldonic acid groups and can be used with particular preference are copolymers of unsaturated carboxylic acids, monomers containing sulfonic acid groups and optionally further ionic or nonionogenic monomers.

In the context of the present invention, preference is given to unsaturated carboxylic acids of the formula X as a monomer
R¹(R²)C═C(R³)COOH (X)
in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms.

Among the unsaturated carboxylic acids which can be described by the formula X, preference is given in particular to acrylic acid (R¹═R²═R³═H), methacrylic acid (R¹═R²═H; R³═CH₃) and/or maleic acid (R¹═COOH; R²═R³═H).

The monomers containing sulfonic acid groups are preferably those of the formula XI
R⁵(R⁶)C═C(R⁷)—X—SO₃H (XI)
in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6,—C(O)—NH—C(CH₃)₂— and —C(O)—NH—CH(CH₂CH₃)—.

Among these monomers, preference is given to those of the formulae XIa, XIb and/or XIc
H₂C═CH—X—SO₃H (XIa)
H₂C═C(CH₃—X—SO₃H (XIb)
HO₃S—X—R⁶)C═C(R⁷)—X—SO₃H (XIc)
in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X═—C(O)NH—CH(CH₂CH₃) in formula XIa), 2-acrylamido-2-propanesulfonic acid (X═—C(O)NH—C(CH₃)₂ in formula XIa), 2-acrylamido-2-methyl-1-propanesulfonic acid (X═—C(O)NH—CH(CH₃)CH₂— in formula XIa), 2-methacrylamido-2-methyl-1-propanesulfonic acid (X═—C(O)NH—CH(CH₃)CH₂— in formula XIb), 3-methacrylamido-2-hydroxypropanesulfonic acid (X═—C(O)NH—CH₂CH(OH)CH₂— in formula XIb), allylsulfonic acid (X═CH₂ in formula XIa), methallylsulfonic acid (X═CH₂ in formula XIb), allyloxybenzenesulfonic acid (X═—CH₂—O—C₆H₄— in formula XIa), methallyloxybenzenesulfonic acid (X═—CH₂—O—C₆H₄— in formula XIb), 2-hydroxy-3-(2-propenyloxy)propanesulfonic acid, 2-methyl-2-propene-1-sulfonic acid (X═CH₂ in formula XIb), styrenesulfonic acid (X═C₆H₄ in formula XIa), vinylsulfonic acid (X not present in formula XIa), 3-sulfopropyl acrylate (X═—C(O)NH—CH₂CH₂CH₂— in formula XIa), 3-sulfopropyl methacrylate (X═—C(O)NH—CH₂CH₂CH₂— in formula XIb), sulfomethacrylamide (X═—C(O)NH— in formula XIb), sulfomethylmethacrylamide (X═—C(O)NH—CH₂— in formula XIb) and water-soluble salts of the acids mentioned.

Useful further ionic or nonionogenic monomers are in particular ethylenically unsaturated compounds. The content of monomers of group iii) in the polymers used in accordance with the invention is preferably less than 20% by weight, based on the polymer. Polymers to be used with particular preference consist only of monomers of groups i) and ii).

In summary, particular preference is given to copolymers of
i) unsaturated carboxylic acids of the formula X
   R¹(R²)C═C(R³)COOH (X)
   in which R¹ to R³ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms,
ii) monomers of the formula XI containing sulfonic acid groups
   R⁵(R⁶)C═C(R⁷)—X—SO₃H (XI)
   in which R⁵ to R⁷ are each independently —H, —CH₃, a straight-chain or branched saturated alkyl radical having from 2 to 12 carbon atoms, a straight-chain or branched, mono- or polyunsaturated alkenyl radical having from 2 to 12 carbon atoms, alkyl or alkenyl radicals as defined above and substituted by —NH₂, —OH or —COOH, or are —COOH or —COOR⁴ where R⁴ is a saturated or unsaturated, straight-chain or branched hydrocarbon radical having from 1 to 12 carbon atoms, and X is an optionally present spacer group which is selected from —(CH₂)ₙ— where n=from 0 to 4, —COO—(CH₂)ₖ— where k=from 1 to 6,—C(O)—NH—C(CH₃)₂— and —C(O)—NH—CH(CH₂CH₃)—
iii) optionally further ionic or nonionogenic monomers.

Further particularly preferred copolymers consist of
i) one or more unsaturated carboxylic acids from the group of acrylic acid, methacrylic acid and/or maleic acid,
ii) one or more monomers containing sulfonic acid groups of the formulae XIa, XIb and/or XIc:
   H₂C═CH—X—SO₃H (XIa)
   H₂C═C(CH₃)—X—SO₃H (XIb)
   HO₃S—X—(R⁶)C═C(R⁷)—X—SO₃H (XIc)
   in which R⁶ and R⁷ are each independently selected from —H, —CH₃, —CH₂CH₃, —CH₂CH₂CH₃, —CH(CH₃)₂ and X is an optionally present spacer group which is selected from —(CH₂)ₙ— where n=from 0 to 4, —COO—(CH₂)ₖ— where k=from 1 to 6, —C(O)—NH—C(CH₃)₂— and —C(O)—NH—CH(CH₂CH₃)—
iii) optionally further ionic or nonionogenic monomers.

The copolymers may contain the monomers from groups i) and ii) and optionally iii) in varying amounts, and it is possible to combine any of the representatives from group i) with any of the representatives from group ii) and any of the representatives from group iii). Particularly preferred polymers have certain structural units which are described below.

Thus, preference is given, for example, to copolymers which contain structural units of the formula XII
—[CH₂—CHCOOH]ₘ—[CH₂—CHC(O)—Y—SO₃H]ₚ— (XII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

These polymers are prepared by copolymerization of acrylic acid with an acrylic acid derivative containing sulfonic acid groups. Copolymerizing the acrylic acid derivative containing sulfonic acid groups with methacrylic acid leads to another polymer, the use of which is likewise preferred. The corresponding copolymers contain structural units of the formula XIII
—[CH₂—C(CH₃)COOH]ₘ—[CH₂—CHC(O)—Y—SO₃H]ₚ— (XIII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Acrylic acid and/or methacrylic acid can also be copolymerized entirely analogously with methacrylic acid derivatives containing sulfonic acid groups, which changes the structural units within the molecule. Thus, copolymers which contain structural units of the formula XIV
—[CH₂—CHCOOH]ₘ—[CH₂—C(CH₃)C(O)—Y—SO₃H]ₚ— (XIV)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, are just as preferred as copolymers which contain structural units of the formula XV
—[CH₂—C(CH₃)COOH]ₘ—[CH₂—C(CH₃)C(O)—Y—SO₃H]ₚ— (XV)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

Instead of acrylic acid and/or methacrylic acid, or in addition thereto, it is also possible to use maleic acid as a particularly preferred monomer from group i). This leads to copolymers which are preferred in accordance with the invention and contain structural units of the formula XVI
—[HOOCCH—CHCOOH]ₘ—[CH₂—CHC(O)—Y—SO₃H]ₚ— (XVI)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—, and to copolymers which are preferred in accordance with the invention and contain structural units of the formula XVII
—[HOOCCH—CHCOOH]ₘ—[CH₂—C(CH₃)C(O)O—Y—SO₃H]ₚ— (XVII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ—where n=from 0 to 4, is —O—(C₆H₄)—, is —NH—C(CH₃)₂— or —NH—CH(CH₂CH₃)—.

In summary, preference is given according to the invention to those copolymers which contain structural units of the formulae XII and/or XIII and/or XIV and/or XV and/or XVI and/or XVII
—[CH₂—CHCOOH]ₘ—[CH₂—CHC(O)—Y—SO₃H]ₚ— (XII)
—[CH₂—C(CH₃)COOH]ₘ—[CH₂—CHC(O)—Y—SO₃H]ₚ— (XIII)
—[CH₂—CHCOOH]ₘ—[CH₂—C(CH₃)C(O)—Y—SO₃H]ₚ— (XIV)
—[CH₂—C(CH₃)COOH]ₘ—[CH₂—C(CH₃)C(O)—Y—SO₃H]ₚ— (XV)
—[HOOCCH—CHCOOH]ₘ—[CH₂—CHC(O)—Y—SO₃H]ₚ— (XVI)
—[HOOCCH—CHCOOH]ₘ—[CH₂—C(CH₃)C(O)O—Y—SO₃H]ₚ— (XVII)
in which m and p are each a whole natural number between 1 and 2000, and Y is a spacer group which is selected from substituted or unsubstituted, aliphatic, aromatic or araliphatic hydrocarbon radicals having from 1 to 24 carbon atoms, preference being given to spacer groups in which Y is —O—(CH₂)ₙ— where n=from 0 to 4, is —O—(C₆H₄)—, is —NH—C(CH₃)₂— or —NH—CH(CH₂CH₃)—.

In the polymers, all or some of the sulfonic acid groups may be in neutralized form, i.e. the acidic hydrogen atom of the sulfonic acid group may be replaced in some or all of the sulfonic acid groups by metal ions, preferably alkali metal ions and in particular by sodium ions. The use of copolymers containing partially or completely neutralized sulfonic acid groups is preferred in accordance with the invention.

The monomer distribution of the copolymers used with preference in accordance with the invention is, in the case of copolymers which contain only monomers from groups i) and ii), preferably in each case from 5 to 95% by weight of i) or ii), more preferably from 50 to 90% by weight of monomer from group i) and from 10 to 50% by weight of monomer from group ii), based in each case on the polymer.

In the case of terpolymers, particular preference is given to those which contain from 20 to 85% by weight of monomer from group i), from 10 to 60% by weight of monomer from group ii), and from 5 to 30% by weight of monomer from group iii).

The molar mass of the sulfo copolymers described above and used according to the invention can be varied in order to adapt the properties of the polymers to the desired end use. Preferred laundry detergent or cleaning composition tablets are characterized in that the copolymers have molar masses of from 2000 to 200 000 gmol⁻¹, preferably from 4000 to 25 000 gmol⁻¹ and in particular from 5000 to 15 000 gmol⁻¹.

Particular preference is further given to using amphoteric or cationic polymers. These particularly preferred polymers are characterized in that they have at least one positive charge. Such polymers are preferably water-soluble or water-dispersible, i.e. they have a solubility above 10 mg/ml in water at 25° C.

Particularly preferred cationic or amphoteric polymers contain at least one ethylenically unsaturated monomer unit of the general formula
R¹(R²)C═C(R³)R⁴
in which R¹ to R⁴ are each independently —H, —CH₃, a straight-chain or branched, saturated alkyl radical having from 2 to 12 carbon atoms, a straight-chain or branched, mono- or polyunsaturated alkenyl radical having from 2 to 12 carbon atoms, alkyl or alkenyl radicals substituted by —NH₂, —OH or —COOH as defined above, a heteroatomic group having at least one positively charged group, a quaternized nitrogen atom or at least one amine group having a positive charge in the pH range between 2 and 11, or —COOH or —COOR⁵ where R⁵ is a saturated or unsaturated, straight-chain or branched hydrocarbon radical having from 1 to 12 carbon atoms.

Examples of the aforementioned (unpolymerized) monomer units are diallylamine, methyldiallylamine, dimethyidiallylammonium salts, acrylamidopropyl(trimethyl)ammonium salts (R¹, R² and R³═H, R⁴═C(O)NH(CH₂)₂N⁺(CH₃)₃X⁻), methacrylamidopropyl(trimethyl)ammonium salts (R¹ and R²═H, R³═CH₃, H, R⁴═C(O)NH(CH₂)₂N⁺(CH₃)₃X⁻).

Particular preference is given to using, as a constituent of the amphoteric polymers, unsaturated carboxylic acids of the general formula
R¹(R²)C═C(R³)COOH
in which R¹ to R³ are each independently —H, —CH₃, a straight-chain or branched, saturated alkyl radical having from 2 to 12 carbon atoms, a straight-chain or branched, mono- or polyunsaturated alkenyl radical having from 2 to 12 carbon atoms, alkyl or alkenyl radicals substituted by —NH₂, —OH or —COOH as defined above or —COOH or —COOR⁴ where R⁴ is a saturated or unsaturated, straight-chain or branched hydrocarbon radical having from 1 to 12 carbon atoms.

Particularly preferred amphoteric polymers contain, as monomer units, derivatives of diallylamine, in particular dimethyldiallylammonium salt and/or methacrylamidopropyl(trimethyl)ammonium salt, preferably in the form of the chloride, bromide, iodide, hydroxide, phosphate, sulfate, hydrosulfate, ethylsulfate, methylsulfate, mesylate, tosylate, formate or acetate in combination with monomer units from the group of the ethylenically unsaturated carboxylic acids.

Bleaches

Among the compounds which serve as bleaches and supply H₂O₂ in water, sodium percarbonate is of particular significance. Further bleaches which can be used are, for example, sodium perborate tetrahydrate and sodium perborate monohydrate, peroxypyrophosphates, citrate perhydrates, and H₂O₂-supplying peracidic salts or peracids, such as perbenzoates, peroxophthalates, diperazelaic acid, phthaloimino peracid or diperdodecanedioic acid. According to the invention, it is also possible to use bleaches from the group of organic bleaches. Typical organic bleaches are the diacyl peroxides, for example dibenzoyl peroxide. Further typical organic bleaches are the peroxy acids, particular examples being the alkyl peroxy acids and the aryl peroxy acids. Preferred representatives are (a) the peroxybenzoic acid and ring-substituted derivatives thereof, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid [phthaloiminoperoxy-hexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid and N,N-terephthaloyldi(6-aminopercaproic acid).

Bleaches used may also be substances which release chlorine or bromine. Among suitable chlorine- or bromine-releasing materials, useful examples include heterocyclic N-bromoamides and N-chloroamides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethylhydantoin, are likewise suitable.

Bleach Activators

Bleach activators are used, for example, in laundry detergents or cleaning compositions, in order to achieve improved bleaching action at temperatures of 60° C. and below. Bleach activators which may be used are compounds which, under perhydrolysis conditions, give rise to aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran.

Further bleach activators used with preference in the context of the present invention are compounds from the group of the cationic nitriles, especially cationic nitriles of the formula 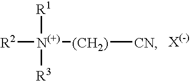
in which R¹ is —H, —CH₃, a C₂₋₂₄-alkyl or -alkenyl radical, a substituted C₂₋₂₄-alkyl or -alkenyl radical having at least one substituent from the group of —Cl, —Br, —OH, —NH₂, —CN, an alkyl- or alkenylaryl radical having a C₁₋₂₄-alkyl group, or is a substituted alkyl- or alkenylaryl radical having a C₁₋₂₄-alkyl group and at least one further substituent on the aromatic ring, R² and R³ are each independently selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂—CH₂—O)ₙH where n=1, 2, 3, 4, 5 or 6, and X is an anion.

Particular preference is given to a cationic nitrile of the formula 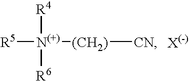
in which R⁴, R⁵ and R⁶ are each independently selected from —CH₃, —CH₂—CH₃, —CH₂—CH₂—CH₃, —CH(CH₃—CH₃, where R⁴ may additionally also be —H, and X is an anion, it being preferred that R⁵═R⁶═—CH₃ and in particular R⁴═R⁵═R⁶═—CH₃, and particular preference being given to compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻or (HO—CH₂—CH₂)₃N⁽⁺⁾CH₂—CN X⁻, particular preference being given in turn, from this group of substances, to the cationic nitrile of the formula (CH₃)₃N⁽⁺⁾CH₂—CN X⁻ in which X⁻ is an anion which is selected from the group of chloride, bromide, iodide, hydrogensulfate, methosulfate, p-toluenesulfonate (tosylate) or xylenesulfonate.

The bleach activators used may also be compounds which, under perhydrolysis conditions, give rise to aliphatic peroxocarboxylic acids having preferably from 1 to 10 carbon atoms, in particular from 2 to 4 carbon atoms, and/or optionally substituted perbenzoic acid. Suitable substances bear O-acyl and/or N-acyl groups of the number of carbon atoms specified, and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate, 2,5-diacetoxy-2,5-dihydrofuran, n-methylmorpholiniumacetonitrile methylsulfate (MMA), and also acetylated sorbitol and mannitol or mixtures thereof (SORMAN), acylated sugar derivatives, in particular pentaacetylglucose (PAG), pentaacetylfructose, tetraacetylxylose and octaacetyllactose, and acetylated, optionally N-alkylated, glucamine and gluconolactone, and/or N-acylated lactams, for example N-benzoylcaprolactam. Hydrophilically substituted acylacetals and acyllactams are likewise used with preference. Combinations of conventional bleach activators can also be used.

In addition to the conventional bleach activators, or instead of them, it is also possible to incorporate so-called bleach catalysts. These substances are bleach-boosting transition metal salts or transition metal complexes, for example salen or carbonyl complexes of Mn, Fe, Co, Ru or Mo. It is also possible to use complexes of Mn, Fe, Co, Ru, Mo, Ti, V and Cu with N-containing tripod ligands, and also Co—, Fe—, Cu— and Ru-ammine complexes as bleach catalysts.

When further bleach activators are to be used in addition to the nitrile quats, preference is given to using bleach activators from the group of the polyacylated alkylenediamines, in particular tetraacetylethylenediamine (TAED), N-acylimides, in particular N-nonanoylsuccinimide (NOSI), acylated phenolsulfonates, in particular n-nonanoyl- or isononanoyloxybenzenesulfonate (n- or iso-NOBS), n-methylmorpholinium-acetonitrile methylsulfate (MMA), preferably in amounts up to 10% by weight, in particular from 0.1% by weight to 8% by weight, particularly from 2 to 8% by weight and more preferably from 2 to 6% by weight, based in each case on the total weight of the composition containing bleach activator.

Bleach-boosting transition metal complexes, in particular with the central atoms Mn, Fe, Co, Cu, Mo, V, Ti and/or Ru, preferably selected from the group of manganese and/or cobalt salts and/or complexes, more preferably the cobalt (ammine) complexes, the cobalt (acetate) complexes, the cobalt (carbonyl) complexes, the chlorides of cobalt or manganese, and manganese sulfate, are used in customary amounts, preferably in an amount up to 5% by weight, in particular from 0.0025% by weight to 1% by weight and more preferably from 0.01% by weight to 0.25% by weight, based in each case on the total weight of the composition containing bleach activator. In specific cases, though, it is also possible to use a greater amount of bleach activator.

Glass Corrosion Inhibitors

Glass corrosion inhibitors prevent the occurrence of opacity, streaks and scratches, but also the iridescence of the glass surface of machine-cleaned glasses. Preferred glass corrosion inhibitors stem from the group of the magnesium and/or zinc salts and/or magnesium and/or zinc complexes.

A preferred class of compounds which can be used to prevent glass corrosion is that of insoluble zinc salts.

In the context of this preferred embodiment, insoluble zinc salts are zinc salts which have a maximum solubility of 10 grams of zinc salt per liter of water at 20—C. Examples of insoluble zinc salts which are particularly preferred in accordance with the invention are zinc silicate, zinc carbonate, zinc oxide, basic zinc carbonate (Zn₂(OH)₂CO₃), zinc hydroxide, zinc oxalate, zinc monophosphate (Zn₃(PO₄)₂) and zinc pyrophosphate (Zn₂(P₂O₇)).

The zinc compounds mentioned are preferably used in amounts which bring about a content of zinc ions in the compositions of between 0.02 and 10% by weight, preferably between 0.1 and 5.0% by weight and in particular between 0.2 and 1.0% by weight, based in each case on the overall composition containing glass corrosion inhibitor. The exact content in the compositions of the zinc salt or the zinc salts is by its nature dependent on the type of the zinc salts—the less soluble the zinc salt used, the higher its concentration in the inventive compositions.

Since the insoluble zinc salts remain for the most part unchanged during the dishwashing operation, the particle size of the salts is a criterion to be considered, so that the salts do not adhere to glassware or parts of the machine. Preference is given here to compositions in which the insoluble zinc salts have a particle size below 1.7 millimeters.

When the maximum particle size of the insoluble zinc salts is less than 1.7 mm, there is no risk of insoluble residues in the dishwasher. The insoluble zinc salt preferably has an average particle size which is distinctly below this value in order to further minimize the risk of insoluble residues, for example an average particle size of less than 250 μm. The lower the solubility of the zinc salt, the more important this is. In addition, the glass corrosion-inhibiting effectiveness increases with decreasing particle size. In the case of very sparingly soluble zinc salts, the average particle size is preferably below 100 μm. For even more sparingly soluble salts, it may be lower still; for example, average particle sizes below 100 μm are preferred for the very sparingly soluble zinc oxide.

A further preferred class of compounds is that of magnesium and/or zinc salt(s) of at least one monomeric and/or polymeric organic acid. These have the effect that, even upon repeated use, the surfaces of glassware are not altered as a result of corrosion, and in particular no clouding, smears or scratches, and also no iridescence of the glass surfaces, are caused.

Even though all magnesium and/or zinc salt(s) of monomeric and/or polymeric organic acids may be used, preference is given, as described above, to the magnesium and/or zinc salts of monomeric and/or polymeric organic acids from the groups of the unbranched, saturated or unsaturated monocarboxylic acids, the branched, saturated or unsaturated monocarboxylic acids, the saturated and unsaturated dicarboxylic acids, the aromatic mono-, di- and tricarboxylic acids, the sugar acids, the hydroxy acids, the oxo acids, the amino acids and/or the polymeric carboxylic acids.

The spectrum of the zinc salts, preferred in accordance with the invention, of organic acids, preferably of organic carboxylic acids, ranges from salts which are sparingly soluble or insoluble in water, i.e. have a solubility below 100 mg/l, preferably below 10 mg/l, in particular have zero solubility, to those salts which have a solubility in water above 100 mg/l, preferably above 500 mg/l, more preferably above 1 g/l and in particular above 5 g/l (all solubilities at water temperature 20-C). The first group of zinc salts includes, for example, zinc citrate, zinc oleate and zinc stearate; the group of soluble zinc salts includes, for example, zinc formate, zinc acetate, zinc lactate and zinc gluconate.

With particular preference, the glass corrosion inhibitor used is at least one zinc salt of an organic carboxylic acid, more preferably a zinc salt from the group of zinc stearate, zinc oleate, zinc gluconate, zinc acetate, zinc lactate and/or zinc citrate. Preference is also given to zinc ricinoleate, zinc abietate and zinc oxalate.

In the context of the present invention, the content of zinc salt in cleaning compositions is between 0.1 and 5% by weight, preferably between 0.2 and 4% by weight and in particular between 0.4 and 3% by weight, or the content of zinc in oxidized form (calculated as Zn²⁺) is between 0.01 and 1% by weight, preferably between 0.02 and 0.5% by weight and in particular between 0.04 and 0.2% by weight, based in each case on the total weight of the composition containing glass corrosion inhibitor.

Corrosion Inhibitors

Corrosion inhibitors serve to protect the ware or the machine, particularly silver protectants having particular significance in the field of machine dishwashing. It is possible to use the known substances from the prior art. In general, it is possible in particular to use silver protectants selected from the group of the triazoles, the benzotriazoles, the bisbenzotriazoles, the aminotriazoles, the alkylaminotriazoles and the transition metal salts or complexes. Particular preference is given to using benzotriazole and/or alkylaminotriazole. Examples of the 3-amino-5-alkyl-1,2,4-triazoles to be used with preference in accordance with the invention include: 5-propyl-, -butyl-, -pentyl-, -heptyl-, -octyl-, -nonyl-, -decyl-, -undecyl-, -dodecyl-, -isononyl-, -Versatic-10 acid alkyl-, -phenyl-, -p-tolyl-, -(4-tert-butylphenyl)-, -(4-methoxyphenyl)-, -(2-, -3-, -4-pyridyl)-, -(2-thienyl)-, -(5-methyl-2-furyl)-, -(5-oxo-2-pyrrolidinyl)-3-amino-1,2,4-triazole. In machine dishwasher detergents, the alkylamino-1,2,4-triazoles or their physiologically compatible salts are used in a concentration of from 0.001 to 10% by weight, preferably from 0.0025 to 2% by weight, more preferably from 0.01 to 0.04% by weight. Preferred acids for the salt formation are hydrochloric acid, sulfuric acid, phosphoric acid, carbonic acid, sulfurous acid, organic carboxylic acids such as acetic acid, glycolic acid, citric acid, succinic acid. Very particularly effective are 5-pentyl, 5-heptyl, 5-nonyl, 5-undecyl, 5-isononyl, 5-Versatic-10 acid alkyl-3-amino-1,2,4-triazoles, and also mixtures of these substances.

Frequently also found in cleaning formulations are active chlorine-containing agents which can significantly reduce the corrosion of the silver surface. In chlorine-free cleaners, particularly oxygen- and nitrogen-containing organic redox-active compounds, such as di- and trihydric phenols, for example hydroquinone, pyrocatechol, hydroxyhydroquinone, gallic acid, phloroglucine, pyrogallol and derivatives of these classes of compound are used. Salt- and complex-type inorganic compounds, such as salts of the metals Mn, Ti, Zr, Hf, V, Co and Ce, also frequently find use. Preference is given in this context to the transition metal salts which are selected from the group of manganese and/or cobalt salts and/or complexes, more preferably cobalt (ammine) complexes, cobalt (acetate) complexes, cobalt (carbonyl) complexes, the chlorides of cobalt or manganese, and manganese sulfate. Zinc compounds may likewise be used to prevent corrosion on the ware.

Instead of or in addition to the above-described silver protectants, for example the benzotriazoles, it is possible to use redox-active substances. These substances are preferably inorganic redox-active substances from the group of the manganese, titanium, zirconium, hafnium, vanadium, cobalt and cerium salts and/or complexes, the metals preferably being in one of the oxidation states II, III, IV, V or VI.

The metal salts or metal complexes used should be at least partially soluble in water. The counterions suitable for the salt formation include all customary singly, doubly or triply negatively charged inorganic anions, for example oxide, sulfate, nitrate, fluoride, but also organic anions, for example stearate.

Metal complexes in the context of the invention are compounds which consist of a central atom and one or more ligands, and optionally additionally one or more of the abovementioned anions. The central atom is one of the abovementioned metals in one of the abovementioned oxidation states. The ligands are neutral molecules or anions which are mono- or polydentate; the term “ligands” in the context of the invention is explained in more detail, for example, in “Römpp Chemie Lexikon, Georg Thieme Verlag, Stuttgart/New York, 9th edition, 1990, page 2507.” When the charge of the central atom and the charge of the ligand(s) within a metal complex do not add up to zero, depending on whether there is a cationic or an anionic charge excess, either one or more of the abovementioned anions or one or more cations, for example sodium, potassium, ammonium ions, ensure that the charge balances. Suitable complexing agents are, for example, citrate, acetyl acetonate or 1-hydroxyethane-1,1-diphosphonate.

The definition of “oxidation state” customary in chemistry is reproduced, for example, in “Römpp Chemie Lexikon, Georg Thieme Verlag, Stuttgart/New York, 9th edition, 1991, page 3168.”

Particularly preferred metal salts and/or metal complexes are selected from the group of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, CoSO₄, Co(NO₃)₂, Ce(NO₃)₃, and mixtures thereof, so that preferred inventive machine dishwasher detergents are characterized in that the metal salts and/or metal complexes are selected from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃.

These metal salts or metal complexes are generally commercial substances which can be used in the inventive compositions for the purposes of silver corrosion protection without prior cleaning. For example, the mixture of penta- and tetravalent vanadium (V₂O₅, VO₂, V₂O₄) known from the preparation of SO₃ (contact process) is therefore suitable, as is the titanyl sulfate, TiOSO₄, which is obtained by diluting a Ti(SO₄)₂ solution.

The inorganic redox-active substances, especially metal salts or metal complexes, are preferably coated, i.e. covered completely with a material which is water-tight, but slightly soluble at the cleaning temperatures, in order to prevent their premature disintegration or oxidation in the course of storage. Preferred coating materials which are applied by known methods, for instance melt coating method according to Sandwik from the foods industry, are paraffins, microcrystalline waxes, waxes of natural origin, such as carnauba wax, candelilla wax, beeswax, relatively high-melting alcohols, for example hexadecanol, soaps or fatty acids. The coating material which is solid at room temperature is applied to the material to be coated in the molten state, for example by centrifuging finely divided material to be coated in a continuous stream through a likewise continuously generated spray-mist zone of the molten coating material. The melting point has to be selected such that the coating material readily dissolves or rapidly melts during the silver treatment. The melting point should ideally be in the range between 45-C and 65-C and preferably in the 50-C to 60-C range.

The metal salts and/or metal complexes mentioned are present in cleaning compositions preferably in an amount of from 0.05 to 6% by weight, preferably from 0.2 to 2.5% by weight, based in each case on the overall composition containing corrosion inhibitor.

Enzymes

To increase the washing or cleaning performance of laundry detergents or cleaning compositions, it is possible to use enzymes. These include in particular proteases, amylases, lipases, hemicellulases, cellulases or oxidoreductases, and preferably mixtures thereof. These enzymes are in principle of natural origin; starting from the natural molecules, improved variants are available for use in detergents and are preferably used accordingly. Inventive compositions preferably contain enzymes in total amounts of from 1×10⁻⁶ to 5 percent by weight based on active protein. The protein concentration may be determined with the aid of known methods, for example the BCA method or the biuret method.

Among the proteases, preference is given to those of the subtilisin type. Examples thereof include the subtilisins BPN' and Carlsberg, protease PB92, the subtilisins 147 and 309, Bacillus lentus alkaline protease, subtilisin DY and the enzymes thermitase and proteinase K which can be classified to the subtilases but no longer to the subtilisins in the narrower sense, and the proteases TW3 and TW7. The subtilisin Carlsberg is available in a developed form under the trade name Alcalase® from Novozymes A/S, Bagsvaerd, Denmark. The subtilisins 147 and 309 are sold under the trade names Esperase® and Savinase® respectively by Novozymes. The variants listed under the name BLAP® are derived from the protease of Bacillus lentus DSM 5483.

Further examples of useful proteases are the enzymes available under the trade names Durazym®, Relase®, Everlase®, Nafizym, Natalase®, Kannase® and Ovozymes® from Novozymes, those under the trade names Purafect®, Purafect®OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan and that under the name Proteinase K-16 from Kao Corp., Tokyo, Japan.

Examples of amylases which can be used in accordance with the invention are the α-amylases from Bacillus licheniformis, from B. amyloliquefaciens or from B. stearothermophilus and developments thereof which have been improved for use in laundry detergents and cleaning compositions. The B. licheniformis enzyme is available from Novozymes under the name Termamyl® and from Genencor under the name Purastar®ST. Development products of this α-amylase are obtainable from Novozymes under the trade names Duramyl® and Termamyl®ultra, from Genencor under the name Purastar®OxAm and from Daiwa Seiko Inc., Tokyo, Japan as Keistase®. The B. amyloliquefaciens α-amylase is sold by Novozymes under the name BAN®, and variants derived from the B. stearothermophilus α-amylase under the names BSG® and Novamyl®, likewise from Novozymes.

Enzymes which should additionally be emphasized for this purpose are the α-amylase from Bacillus sp. A 7-7 (DSM 12368), and the cyclodextrin glucanotransferase (CGTase) from B. agaradherens (DSM 9948).

Also suitable are the developments of α-amylase from Aspergillus niger and A. oryzae, which are available under the trade names Fungamyl® from Novozymes. Another commercial product is Amylase-LT®, for example.

Furthermore, lipases or cutinases may be used according to the invention, especially owing to their triglyceride-cleaving activities, but also in order to generate peracids in situ from suitable precursors. Examples thereof include the lipases which were originally obtainable from Humicola lanuginosa (Thermomyces lanuginosus) or have been developed, in particular those with the D96L amino acid substitution. They are sold, for example, under the trade names Lipolase®, Lipolase®Ultra, LipoPrime®, Lipozyme® and Lipex® from Novozymes. It is additionally possible, for example, to use the cutinases which have originally been isolated from Fusarium solani pisi and Humicola insolens. Lipases which are also useful can be obtained under the designations Lipase CE®, Lipase P®, Lipase B®, Lipase CES®, Lipase AKG®, Bacillis sp. Lipase®, Lipase AP®, Lipase M-AP® and Lipase AML® from Amano. Examples of lipases and cutinases from Genencor which can be used are those whose starting enzymes have originally been isolated from Pseudomonas mendocina and Fusarium solanii. Other important commercial products include the M1 Lipase® and Lipomax® preparations originally sold by Gist-Brocades and the enzymes sold under the names Lipase MY-30®, Lipase OF® and Lipase PL® by Meito Sangyo KK, Japan, and also the product Lumafast® from Genencor.

It is also possible to use enzymes which are combined under the term hemicellulases. These include, for example, mannanases, xanthane lyases, pectin lyases (=pectinases), pectin esterases, pectate lyases, xyloglucanases (=xylanases), pullulanases and β-glucanases. Suitable mannanases are available, for example, under the names Gamanase® and Pektinex AR® from Novozymes, under the name Rohapec® B1 L from AB Enzymes and under the name Pyrolase® from Diversa Corp., San Diego, Calif., USA. The β-glucanase obtained from B. subtilis is available under the name Cereflo® from Novozymes.

To enhance the bleaching action, inventive detergents may comprise oxidoreductases, for example oxidases, oxygenases, catalases, peroxidases, such as haloperoxidases, chloroperoxidases, bromoperoxidases, lignin peroxidases, glucose peroxidases or manganese peroxidases, dioxygenases or laccases (phenol oxidases, polyphenol oxidases). Suitable commercial products include Denilite® 1 and 2 from Novozymes. Advantageously, preferably organic, more preferably aromatic, compounds which interact with the enzymes are additionally added in order to enhance the activity of the oxidoreductases concerned (enhancers), or to ensure the electron flux in the event of large differences in the redox potentials of the oxidizing enzymes and the soilings (mediators).

The enzymes derive, for example, either originally from microorganisms, for example of the genera Bacillus, Streptomyces, Humicola, or Pseudomonas, and/or are produced in biotechnology processes known per se by suitable microorganisms, for instance by transgenic expression hosts of the genera Bacillus or filamentous fungi.

The enzymes in question are favorably purified via processes which are established per se, for example via precipitation, sedimentation, concentration, filtration of the liquid phases, microfiltration, ultrafiltration, the action of chemicals, deodorization or suitable combinations of these steps.

The enzymes may be used in any form established in the prior art. These include, for example, the solid preparations obtained by granulation, extrusion or lyophilization, or, especially in the case of liquid or gel-form compositions, solutions of the enzymes, advantageously highly concentrated, low in water and/or admixed with stabilizers.

Alternatively, the enzymes may be encapsulated either for the solid or for the liquid administration form, for example by spray-drying or extrusion of the enzyme solution together with a preferably natural polymer, or in the form of capsules, for example those in which the enzymes are enclosed as in a solidified gel, or in those of the core-shell type, in which an enzyme-containing core is coated with a water-, air- and/or chemical-impermeable protective layer. It is possible in layers applied thereto to additionally apply further active ingredients, for example stabilizers, emulsifiers, pigments, bleaches or dyes. Such capsules are applied by methods known per se, for example by agitated or roll granulation or in fluidized bed processes. Advantageously, such granules, for example as a result of application of polymeric film formers, are low-dusting and storage-stable owing to the coating.

It is also possible to formulate two or more enzymes together, so that a single granule has a plurality of enzyme activities.

A protein and/or enzyme may be protected, particularly during storage, from damage, for example inactivation, denaturation or decay, for instance by physical influences, oxidation or proteolytic cleavage. When the proteins and/or enzymes are obtained microbially, particular preference is given to inhibiting proteolysis, especially when the compositions also comprise proteases. For this purpose, inventive compositions may comprise stabilizers; the provision of such compositions constitutes a preferred embodiment of the present invention.

One group of stabilizers is that of reversible protease inhibitors. Frequently, benzamidine hydrochloride, borax, boric acids, boronic acids or salts or esters thereof are used, and of these in particular derivatives having aromatic groups, for example ortho-substituted, meta-substituted and para-substituted phenylboronic acids, or the salts or esters thereof. Peptidic protease inhibitors which should be mentioned include ovomucoid and leupeptin; an additional option is the formation of fusion proteins of proteases and peptide inhibitors.

Further enzyme stabilizers are amino alcohols such as mono-, di-, triethanol- and -propanolamine and mixtures thereof, aliphatic carboxylic acids up to C₁₂, such as succinic acid, other dicarboxylic acids or salts of the acids mentioned. Terminally capped fatty acid amide alkoxylates can also be used as stabilizers. Certain organic acids used as builders are additionally capable of stabilizing an enzyme present.

Lower aliphatic alcohols, but in particular polyols, for example glycerol, ethylene glycol, propylene glycol or sorbitol, are other frequently used enzyme stabilizers. Calcium salts are likewise used, for example calcium acetate or calcium formate, as are magnesium salts.

Polyamide oligomers or polymeric compounds such as lignin, water-soluble vinyl copolymers or cellulose ethers, acrylic polymers and/or polyamides stabilize the enzyme preparation against influences including physical influences or pH fluctuations. Polyamine N-oxide-containing polymers act simultaneously as enzyme stabilizers. Other polymeric stabilizers are the linear C₈-C₁₈ polyoxyalkylenes. Alkylpolyglycosides can likewise stabilize the enzymatic components of the inventive composition and even increase their performance. Crosslinked N-containing compounds likewise act as enzyme stabilizers.

Reducing agents and antioxidants increase the stability of the enzymes against oxidative decay. An example of a sulfur-containing reducing agent is sodium sulfite.

Preference is given to using combinations of stabilizers, for example of polyols, boric acid and/or borax, the combination of boric acid or borate, reducing salts and succinic acid or other dicarboxylic acids or the combination of boric acid or borate with polyols or polyamino compounds and with reducing salts. The action of peptide-aldehyde stabilizers can be increased by the combination with boric acid and/or boric acid derivatives and polyols, and further enhanced by the additional use of divalent cations, for example calcium ions.

Preference is given to using one or more enzymes and/or enzyme preparations, preferably solid protease preparations and/or amylase preparations, in amounts of from 0.1 to 5% by weight, preferably of from 0.2 to 4.5% by weight and in particular from 0.4 to 4% by weight, based in each case on the overall composition containing enzyme.

Disintegration Assistants

In order to ease the decomposition of prefabricated tablets, it is possible to incorporate disintegration assistants, known as tablet disintegrants, into these compositions, in order to shorten disintegration times. According to Römpp (9th edition, vol. 6, p. 4440) and Voigt “Lehrbuch der pharmazeutischen Technologie” [Textbook of pharmaceutical technology] (6th edition, 1987, p. 182-184), tablet disintegrants or disintegration accelerants refer to assistants which ensure the rapid decomposition of tablets in water or gastric juice and the release of pharmaceuticals in absorbable form.

These substances, which are also referred to as “breakup” agents owing to their action, increase their volume on ingress of water, and it is either the increase in the intrinsic volume (swelling) or the release of gases that can generate a pressure that causes the tablets to disintegrate into smaller particles. Disintegration assistants which have been known for some time are, for example, carbonate/citric acid systems, although other organic acids may also be used. Swelling disintegration assistants are, for example, synthetic polymers such as polyvinylpyrrolidone (PVP) or natural polymers or modified natural substances such as cellulose and starch and derivatives thereof, alginates or casein derivatives.

Preference is given to using disintegration assistants in amounts of from 0.5 to 10% by weight, preferably from 3 to 7% by weight and in particular from 4 to 6% by weight, based in each case on the total weight of the composition comprising disintegration assistant.

Preferred disintegrants used in the context of the present invention are disintegrants based on cellulose, so that preferred laundry detergent and cleaning composition tablets contain such a cellulose-based disintegrant in amounts of from 0.5 to 10% by weight, preferably from 3 to 7% by weight and in particular from 4 to 6% by weight. Pure cellulose has the formal empirical composition (C₆H₁₀O₅)ₙ and, viewed in a formal sense, is a β-1,4-polyacetal of cellobiose which is in turn formed from two molecules of glucose. Suitable celluloses consist of from approx. 500 to 5000 glucose units and accordingly have average molar masses of from 50 000 to 500 000. Useful cellulose-based disintegrants in the context of the present invention are also cellulose derivatives which are obtainable by polymer-like reactions from cellulose. Such chemically modified celluloses comprise, for example, products of esterifications and etherifications in which hydroxyl hydrogen atoms have been substituted. However, celluloses in which the hydroxyl groups have been replaced by functional groups which are not bonded via an oxygen atom can also be used as cellulose derivatives. The group of the cellulose derivatives includes, for example, alkali metal celluloses, carboxymethylcelluloses (CMC), cellulose esters and ethers, and amino celluloses. The cellulose derivatives mentioned are preferably not used alone as disintegrants based on cellulose, but rather in a mixture with cellulose. The content of cellulose derivatives in these mixtures is preferably below 50% by weight, more preferably below 20% by weight, based on the disintegrant based on cellulose. The disintegrant based on cellulose which is used is more preferably pure cellulose which is free of cellulose derivatives.

The cellulose used as a disintegration assistant is preferably not used in finely divided form, but rather converted to a coarser form before admixing with the premixtures to be compressed, for example granulated or compacted. The particle sizes of such disintegrants are usually above 200 μm, preferably to an extent of at least 90% by weight between 300 and 1600 μm and in particular to an extent of at least 90% by weight between 400 and 1200 μm. The aforementioned coarser cellulose-based disintegration assistants which are described in detail in the documents cited are to be used with preference as disintegration assistants in the context of the present invention and are commercially available, for example under the name Arbocel® TF-30-HG from Rettenmaier.

As a further cellulose-based disintegrant or as a constituent of this component, it is possible to use microcrystalline cellulose. This microcrystalline cellulose is obtained by partial hydrolysis of celluloses under conditions which attack and fully dissolve only the amorphous regions (approx. 30% of the total cellulose mass) of the celluloses, but leave the crystalline regions (approx. 70%) undamaged. A subsequent deaggregation of the microfine celluloses formed by the hydrolysis affords the microcrystalline celluloses which have primary particle sizes of approx. 5 μm and can be compacted, for example, to granules having an average particle size of 200 μm.

Disintegration assistants preferred in the context of the present invention, preferably a cellulose-based disintegration assistant, preferably in granulated, cogranulated or compacted form, are present in the compositions containing disintegrant in amounts of from 0.5 to 10% by weight, preferably from 3 to 7% by weight and in particular from 4 to 6% by weight, based in each case on the total weight of the composition containing disintegrant.

According to the invention, gas-evolving effervescent systems may additionally be used as tablet disintegrants. The gas-evolving effervescent system may consist of a single substance which releases a gas on contact with water. Among these compounds, mention should be made of magnesium peroxide in particular, which releases oxygen on contact with water. Typically, however, the gas-releasing effervescent system itself consists of at least two constituents which react with one another to form gas. While a multitude of systems which release, for example, nitrogen, oxygen or hydrogen are conceivable and practicable here, the effervescent system used in the inventive laundry detergent and cleaning composition tablets will be selectable on the basis of both economic and on the basis of environmental considerations. Preferred effervescent systems consist of alkali metal carbonate and/or alkali metal hydrogencarbonate and of an acidifier which is suitable for releasing carbon dioxide from the alkali metal salts in aqueous solution.

In the case of the alkali metal carbonates and/or alkali metal hydrogencarbonates, the sodium and potassium salts are distinctly preferred over the other salts for reasons of cost. It is of course not mandatory to use the pure alkali metal carbonates or alkali metal hydrogencarbonates in question; rather, mixtures of different carbonates and hydrogencarbonates may be preferred.

The effervescent system used is preferably from 2 to 20% by weight, preferably from 3 to 15% by weight and in particular from 5 to 10% by weight of an alkali metal carbonate or alkali metal hydrogencarbonate, and from 1 to 15% by weight, preferably from 2 to 12% by weight and in particular from 3 to 10% by weight of an acidifier, based in each case on the overall weight of the composition.

Acidifiers which release carbon dioxide from the alkali metal salts in aqueous solution and can be used are, for example, boric acid and also alkali metal hydrogensulfates, alkali metal dihydrogenphosphates and other inorganic salts. Preference is given, however, to the use of organic acidifiers, citric acid being a particularly preferred acidifier. However, it is also possible, in particular, to use the other solid mono-, oligo- and polycarboxylic acids. From this group, preference is given in turn to tartaric acid, succinic acid, malonic acid, adipic acid, maleic acid, fumaric acid, oxalic acid, and polyacrylic acid. It is likewise possible to use organic sulfonic acids such as amidosulfonic acid. A commercially available acidifier which can likewise be used with preference in the context of the present invention is Sokalan® DCS (trademark of BASF), a mixture of succinic acid (max. 31% by weight), glutaric acid (max. 50% by weight) and adipic acid (max. 33% by weight).

In the context of the present invention, preference is given to acidifiers in the effervescent system from the group of the organic di-, tri- and oligocarboxylic acids, or mixtures of these.

Fragrances

The perfume oils and/or fragrances used may be individual odorant compounds, for example the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methyl phenylglycinate, allyl cyclohexylpropionate, styrallyl propionate and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial and bourgeonal; the ketones include, for example, the ionones, α-isomethylionone and methyl cedryl ketone; the alcohols include anethole, citronellol, eugenol, geraniol, linalool, phenylethyl alcohol and terpineol; the hydrocarbons include primarily the terpenes such as limonene and pinene. However, preference is given to using mixtures of different odorants which together produce a pleasing fragrance note. Such perfume oils may also comprise natural odorant mixtures, as are obtainable from vegetable sources, for example pine oil, citrus oil, jasmine oil, patchouli oil, rose oil or ylang-ylang oil. Likewise suitable are muscatel, sage oil, chamomile oil, clove oil, balm oil, mint oil, cinnamon leaf oil, lime blossom oil, juniper berry oil, vetiver oil, olibanum oil, galbanum oil and labdanum oil, and also orange blossom oil, neroli oil, orange peel oil and sandalwood oil.

The fragrances can be processed directly, but it may also be advantageous to apply the fragrances to carriers which ensure long-lasting fragrance by slower fragrance release. Such useful carrier materials have been found to be, for example, cyclodextrins, and the cyclodextrin-perfume complexes may additionally also be coated with further assistants.

Dyes

Preferred dyes, whose selection presents no difficulty at all to the person skilled in the art, have high storage stability and insensitivity toward the other ingredients of the compositions and to light, and also have no pronounced substantivity toward the substrates to be treated with the dye-containing compositions, such as glass, ceramic, plastic dishes or textiles, so as not to stain them.

Solvents

The solvents include especially the nonaqueous organic solvents, particular preference being given to using nonaqueous solvents from the group of mono- or polyhydric alcohols, alkanolamines or glycol ethers, provided that they are miscible with water in the concentration range specified. The solvents are preferably selected from ethanol, n- or i-propanol, butanols, glycol, propane- or butanediol, glycerol, diglycol, propyl- or butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether, and mixtures of these solvents.

Foam Inhibitors

Useful foam inhibitors are, for example, soaps, paraffins or silicone oils, which may optionally be applied to carrier materials. Suitable antiredeposition agents, which are also referred to as soil repellents, are, for example, nonionic cellulose ethers, such as methylcellulose and methylhydroxypropylcellulose having a proportion of methoxy groups of from 15 to 30% by weight and of hydroxypropyl groups of from 1 to 15% by weight, based in each case on the nonionic cellulose ethers, and the prior art polymers of phthalic acid and/or terephthalic acid or derivatives thereof, in particular polymers of ethylene terephthalates and/or polyethylene glycol terephthalates or anionically and/or nonionically modified derivatives thereof. Of these, particular preference is given to the sulfonated derivatives of phthalic acid polymers and terephthalic acid polymers.

Optical Brighteners

Optical brighteners (known as “whiteners”) may be added to laundry detergents or cleaning compositions in order to eliminate graying and yellowing of textiles treated with these compositions. These substances attach to the fibers and bring about brightening and simulated bleaching action by converting invisible ultraviolet radiation to visible longer-wavelength light, in the course of which the ultraviolet light absorbed from sunlight is radiated as pale bluish fluorescence and, together with the yellow shade of the grayed or yellowed laundry, results in pure white. Suitable compounds stem, for example, from the substance classes of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles.

Graying Inhibitors

Graying inhibitors in textile cleaning compositions have the task of keeping the soil detached from the fiber suspended in the liquor, thus preventing the soil from reattaching. Suitable for this purpose are water-soluble colloids, usually of organic nature, for example the water-soluble salts of polymeric carboxylic acids, size, gelatin, salts of ether sulfonic acids of starch or of cellulose, or salts of acidic sulfuric esters of cellulose or of starch. Water-soluble polyamides containing acidic groups are also suitable for this purpose. In addition, it is possible to use soluble starch preparations, and starch products other than those mentioned above, for example degraded starch, aldehyde starches, etc. It is also possible to use polyvinylpyrrolidone. Also usable as graying inhibitors in the particulate compositions are cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose and mixtures thereof.

1. A laundry detergent or cleaning composition portion comprising a water-soluble melt adhesive comprising
A) from 40 to 70% by weight of at least one homo- or copolymer having free carboxylic acid groups based on ethylenically unsaturated monomers,
B) from 15 to 45% by weight of at least one water-soluble or water-dispersible polyurethane,
C) from 10 to 45% by weight of at least one inorganic or organic base,
D) from 0 to 20% by weight of further additives.

2. The laundry detergent or cleaning composition portion as claimed in claim 1, characterized in that the water-soluble melt adhesive comprises, as component A, a vinyl acetate-crotonic acid copolymer having an acid number of from 10 to 200 mg KOH/g.

3. The laundry detergent or cleaning composition portion as claimed in claim 1, wherein the water-soluble melt adhesive comprises from 50 to 60% by weight of at least one homo- or copolymer having free carboxylic acid groups based on ethylenically unsaturated monomers.

4. The laundry detergent or cleaning composition portion as claimed in claim 1, wherein the water-soluble melt adhesive comprises from 25 to 35% by weight of at least one water-soluble or water-dispersible polyurethane.

5. The laundry detergent or cleaning composition portion as claimed in claim 1, characterized in that the water-soluble melt adhesive comprises, as component B, a nonionic polyurethane having a viscosity of from 500 to 80,000 mPas at 150° C.

6. The laundry detergent or cleaning composition portion as claimed in claim 1, characterized in that the water-soluble melt adhesive comprises from 15 to 25% by weight of at least one inorganic or organic base.

7. The laundry detergent or cleaning composition portion as claimed in claim 1, characterized in that the water-soluble melt adhesive comprises, as Component C, an alkanolamine having from 2 to 6 carbon atoms in the alkanol radical, where the length of the carbon chain in the alkanol radicals of one molecule may be the same or different.

8. The laundry detergent or cleaning composition portion as claimed in claim 7, characterized in that the alkanolamine having from 2 to 6 carbon atoms in the alkanol radical is triethanolamine.

9. The laundry detergent or cleaning composition portion as claimed in claim 1, characterized in that the water-soluble melt adhesive comprises at least one further additive selected from the group consisting of base polymers, plasticizers, rheological additives, antioxidants, UV stabilizers, dyes or tackifying resins (tackifiers), and water and/or organic solvents, provided that the additives do not impair the water-solubility of the melt adhesive composition.

10. The laundry detergent or cleaning composition portion as claimed in claim 1, characterized in that the water-soluble melt adhesive has a viscosity of from 1,000 to 20,000 mPas.

11. The laundry detergent or cleaning composition portion as claimed in claim 1, characterized in that the laundry detergent or cleaning composition is in the form of a tablet having a cavity.

12. A detergent or cleaning composition portion comprising water-soluble or water-dispersible packaging characterized in that the laundry detergent or cleaning composition portion further comprises a water-soluble melt adhesive comprising
A) from 40 to 70% by weight of at least one homo- or copolymer having free carboxylic acid groups based on ethylenically unsaturated monomers,
B) from 15 to 45% by weight of at least one water-soluble or water-dispersible polyurethane,
C) from 10 to 45% by weight of at least one inorganic or organic base and
D) from 0 to 20% by weight of further additives.

13. A process for producing a laundry detergent or cleaning composition portion by adhesive-bonding at least one constituent of the laundry detergent or cleaning composition portion with a water-soluble melt adhesive which comprises
A) from 40 to 70% by weight of at least one homo- or copolymer having free carboxylic acid groups based on ethylenically unsaturated monomers,
B) from 15 to 45% by weight of at least one water soluble or water-dispersible polyurethane,
C) from 10 to 45% by weight of at least one inorganic or organic base and
D) from 0 to 20% by weight of further additives.

14. The process as claimed in claim 13, comprising the further steps of producing a tablet comprising a cavity by tableting or casting and adhesive-bonding of the tablet comprising a cavity with a further tablet, by means of a water-soluble melt adhesive which comprises
A) from 40 to 70% by weight of at least one homo- or copolymer having free carboxylic acid groups based on ethylenically unsaturated monomers,
B) from 15 to 45% by weight of at least one water-soluble or water-dispersible polyurethane,
C) from 10 to 45% by weight of at least one inorganic or organic base and
D) from 0 to 20% by weight of further additives.

15. The process as claimed in claim 13, comprising the further steps of
a) producing a tablet having a cavity by tableting or casting;
b) filling the depression in the tablet's cavity; and
c) closing the cavity by adhesive-bonding the cavity with a water-soluble or water-dispersible seal, wherien the adhesive bonding is carried out by means of a water-soluble melt adhesive which comprises
A) from 40 to 70% by weight of at least one homo- or copolymer having free carboxylic acid groups based on ethylenically unsaturated monomers,
B) from 15 to 45% by weight of at least one water-soluble or water-dispersible polyurethane,
C) from 10 to 45% by weight of at least one inorganic or organic base and
D) from 0 to 20% by weight of further additives.

16. The process as claimed in claim 13, comprising the further steps of
a) providing a water-soluble or water-dispersible receiving vessel;
b) filling the receiving vessel with washing- or cleaning-active substances;
c) closing the receiving vessel by adhesive-bonding the receiving vessel with a water-soluble or water-dispersible seal, wherein the adhesive bonding is carried out by means of a water-soluble melt adhesive which comprises
A) from 40 to 70% by weight of at least one homo- or copolymer having free carboxylic acid groups based on ethylenically unsaturated monomers,
B) from 15 to 45% by weight of at least one water-soluble or water-dispersible polyurethane,
C) from 10 to 45% by weight of at least one inorganic or organic base and
D) from 0 to 20% by weight of further additives.

17. The process of claim 13, wherein the laundry detergent or cleaning composition portion is in the form of a tablet.

18. The process according to claim 13, wherein the process includes the further step of adhesive-bonding at least one constituent of the laundry detergent or cleaning composition portion to water-soluble or water-dispersible packaging materials.

19. The process as claimed in claim 18, wherein the water-soluble or water-dispersible packaging materials are selected from the group consisting of water-soluble films, water-dispersible films, injected-molded parts and bottle-blown parts.

20. The process as claimed in claim 13, comprising the further step of enveloping the laundry detergent or cleaning composition portion in an adhesive-bonded and sealed water-soluble or water-dispersible thermoformed, injection-molded or bottle-blown receiving vessel.
